(19) United States
(12) Patent Application Publication
(10) Pub. No.: US 2026/0283160 A1
(43) Pub. Date: Sep. 24, 2026

(54) BIOCONTROL COMPOSITIONS AND METHODS

(71) Applicant: Bowling Green State University, Bowling Green, OH (US)

(72) Inventors: Paul F. Morris, Bowling Green, OH (US); Carren Nyambare Burkey, Bowling Green, OH (US)

(73) Assignee: Bowling Green State University, Bowling Green, OH (US)

(21) Appl. No.: 19/469,728

(22) PCT Filed: Mar. 27, 2024
(86) PCT No.: PCT/US2024/021559

§ 371 Date: Sep. 26, 2025

Related U.S. Application Data
(60) Provisional application No. 63/492,276, filed on Mar. 27, 2023.

(51) Int. Cl. A01N 63/27; A01N 25/02; A01P 1/00

(52) U.S. Cl. CPC A01N 63/27; A01N 25/02; A01P 1/00

(57) ABSTRACT

Compositions and methods involving Pseudomonas strains useful for killing oomycetes are described.

### RELATED APPLICATIONS

This application claims priority to U.S. Provisional Application No. 63/492,276 filed under 35 U.S.C. § 111(b) on Mar. 27, 2023, the entire disclosure of which is incorporated herein by reference for all purposes.

### STATEMENT REGARDING FEDERALLY SPONSORED RESEARCH

This invention was made with no government support. The government has no rights in this invention.

### SEQUENCE LISTING

The sequence listing in WIPO Standard ST.26XML format named 4251_62853_Seq_List_IDN-225.xml, created on Mar. 25, 2024 and 46,592 bytes in size, is incorporated herein by reference for all purposes.

### BACKGROUND

Oomycetes, which are fungi-like microorganisms, are increasingly threatening animals and plants. For example, Saprolegnia species adversely affect wild and cultivated populations of amphibians and fish. It is estimated that 10% of all salmon eggs are lost in fish hatcheries due to infections caused by the pathogen Saprolegnia parasitica, which is present in fresh water streams and lakes and known for causing saprolegniosis. As another example, Pythium species are known to cause disease in a wide range of plants, including crops, vegetables, and ornamentals. Hydroponic production of vegetables has gained increased market share because produce can be grown locally and these facilities are more productive and sustainable in their use of inputs like water, fertilizer, and energy than conventional agriculture. Pythium spp have emerged as the most problematic pathogen in the production of leafy greens. There is a need in the art to develop compositions and methods useful for killing oomycetes such as Saprolegnia or Pythium species.

### SUMMARY

Provided is a method of killing oomycetes, the method comprising contacting oomycetes with an effective amount of a combination of at least two strains of pseudomonads to kill the oomycetes.

In certain embodiments, the two strains of pseudomonads comprise Pseudomonas fluorescens. In particular embodiments, the two strains are selected from the group consisting of Pseudomonas fluorescens LE6D7, Pseudomonas fluorescens LE6D8, Pseudomonas fluorescens LE6A6, Pseudomonas fluorescens LE6A8, Pseudomonas fluorescens LE5F1, Pseudomonas fluorescens LE5F7, Pseudomonas fluorescens LE5F8, Pseudomonas fluorescens LE5G2, Pseudomonas fluorescens LE5G8, and Pseudomonas fluorescens LE5H2.

In certain embodiments, the two strains include Pseudomonas fluorescens LE6D7 deposited as ATCC Accession Number PTA-127746. In certain embodiments, the two strains include Pseudomonas fluorescens LE6D8. In certain embodiments, the two strains include Pseudomonas fluorescens LE6A6. In certain embodiments, the combination comprises two of Pseudomonas fluorescens LE6D7, Pseudomonas fluorescens LE6D8, and Pseudomonas fluorescens LE6A6.

In certain embodiments, the oomycetes comprise Saprolegnia parasitica.

In certain embodiments, the oomycetes are on fish eggs. In certain embodiments, the oomycetes are on salmon eggs. In certain embodiments, the oomycetes are on plants.

In certain embodiments, the oomycetes comprise a Pythium species. In particular embodiments, the Pythium species is P. dissoticum, P. oopapillim, or P. heterothalicum.

Further provided is a method of killing oomycetes, the method comprising contacting oomycetes with an effective amount of a pseudomonad strain to kill the oomycetes, wherein the oomycetes comprise a Pythium species.

In certain embodiments, the Pythium species is P. dissoticum.

In certain embodiments, the pseudomonad species is a Pseudomonas fluorescens strain.

In certain embodiments, the pseudomonad strain comprises Pseudomonas fluorescens LE6D7, Pseudomonas fluorescens LE6D8, Pseudomonas fluorescens LE6A6, Pseudomonas fluorescens LE6A8, Pseudomonas fluorescens LE5F1, Pseudomonas fluorescens LE5F7, Pseudomonas fluorescens LE5F8, Pseudomonas fluorescens LE5G2, Pseudomonas fluorescens LE5G8, or Pseudomonas fluorescens LE5H2.

In certain embodiments, the pseudomonad strain is Pseudomonas fluorescens LE6D7 deposited as ATCC Accession Number PTA-127746. In certain embodiments, the pseudomonad strain is Pseudomonas fluorescens LE6D8. In certain embodiments, the pseudomonad strain is Pseudomonas fluorescens LE6A6.

Further provided is a composition comprising at least one genetically altered variant of a pseudomonad species collected from Lake Eric. In certain embodiments, the strain is Pseudomonas fluorescens LE6D7. In certain embodiments, the strain is Pseudomonas fluorescens LE6D8. In certain embodiments, the strain is Pseudomonas fluorescens LE6A8.

Further provided is the use of an organism having a type VI secretion system (T6SS) to kill oomycetes. In certain embodiments, the oomycetes are Saprolegnia or Pythium species.

Further provided is a biocontrol composition comprising an effective amount of a strain of pseudomonad; and one or more solvents, emulsifiers, surfactants, stabilizers, colorants, and fragrances; wherein the effective amount causes contact-dependent killing of oomycetes. In certain embodiments, the pseudomonad strain comprises Pseudomonas fluorescens LE6D7, Pseudomonas fluorescens LE6D8, Pseudomonas fluorescens LE6A6, Pseudomonas fluorescens LE6A8, Pseudomonas fluorescens LE5F1, Pseudomonas fluorescens LE5F7, Pseudomonas fluorescens LE5F8, Pseudomonas fluorescens LE5G2, Pseudomonas fluorescens LE5G8, or Pseudomonas fluorescens LE5H2. In certain embodiments, the strain is Pseudomonas fluorescens LE6D7, Pseudomonas fluorescens LE6D8, or Pseudomonas fluorescens LE6A8.

Further provided is a method of cleansing a hydroponic system, the method comprising adding an effective amount of at least one pseudomonad strain capable of contact-dependent killing of oomycetes into water of the hydroponic system, and cleansing the hydroponic system of pythium propagules. In certain embodiments, the pseudomonad strain comprises Pseudomonas fluorescens LE6D7, Pseudomonas fluorescens LE6D8, Pseudomonas fluorescens LE6A6, Pseudomonas fluorescens LE6A8, Pseudomonas fluorescens LE5F1, Pseudomonas fluorescens LE5F7, Pseudomonas fluorescens LE5F8, Pseudomonas fluorescens LE5G2, Pseudomonas fluorescens LE5G8, or Pseudomonas fluorescens LE5H2.

Further provided is a biocontrol composition comprising a Pseudomonad species having a type VI secretion system (T6SS) capable of delivering proteins into a host; and an agriculturally acceptable carrier. In certain embodiments, the T6SS is characterized by including at least one of SEQ ID Nos: 1-37. In certain embodiments, the T6SS secretes at least one of SEQ ID Nos. 1-7. In certain embodiments, the T6SS is characterized by including at least one of SEQ ID Nos. 18-37. In certain embodiments, the Pseudomonad species comprises Pseudomonas fluorescens LE6D7, Pseudomonas fluorescens LE6D8, Pseudomonas fluorescens LE6A6, Pseudomonas fluorescens LE6A8, Pseudomonas fluorescens LE5F1, Pseudomonas fluorescens LE5F7, Pseudomonas fluorescens LE5F8, Pseudomonas fluorescens LE5G2, Pseudomonas fluorescens LE5G8, or Pseudomonas fluorescens LE5H2.

Further provided is a method of killing oomycetes, the method comprising contacting oomycetes with an organism having a type VI secretion system (T6SS) which secretes at least one of SEQ ID Nos. 1-7 and killing the oomycetes. In certain embodiments, the T6SS secretes at least two of SEQ ID Nos. 1-7. In certain embodiments, the T6SS secretes at least three of SEQ ID Nos. 1-7. In certain embodiments, the T6SS secretes at least four of SEQ ID Nos. 1-7. In certain embodiments, the T6SS secretes at least five of SEQ ID Nos. 1-7. In certain embodiments, the T6SS secretes at least six of SEQ ID Nos. 1-7. In certain embodiments, the T6SS secretes each of SEQ ID Nos. 1-7. In certain embodiments, the oomycetes comprise a Pythium species. In certain embodiments, the oomycetes comprise a Saprolegnia species. In certain embodiments, the organism is a Pseudomonad species. In certain embodiments, the organism is a strain of Pseudomonas fluorsecens. In certain embodiments, the organism is selected from the group consisting of Pseudomonas fluorescens LE6D7, Pseudomonas fluorescens LE6D8, Pseudomonas fluorescens LE6A6, Pseudomonas fluorescens LE6A8, Pseudomonas fluorescens LE5F1, Pseudomonas fluorescens LE5F7, Pseudomonas fluorescens LE5F8, Pseudomonas fluorescens LE5G2, Pseudomonas fluorescens LE5G8, and Pseudomonas fluorescens LE5H2.

Further provided is a method of killing an oomycete in a location, the method comprising introducing into the location an amount of a cell suspension, supernatant, filtrate, cell fraction, or whole cell broth derived from a Pseudomonas fluorescens LE6D7 deposited as ATCC Accession No. PTA-127746, effective to kill the oomycete.

Further provided is a biocontrol composition comprising a Pseudomonas fluorescens LE6D7 deposited as ATCC Accession No. PTA-127746.

Further provided is a biocontrol composition comprising an organism genetically modified to secrete one or more of SEQ ID Nos. 1-7 through a type VI secretion system (T6SS); and an agriculturally acceptable carrier.

Further provided is a biological anti-oomycete product comprising a stabilized suspension of a Pseudomonas organism having a type VI secretion system (T6SS) characterized by one or more of SEQ ID Nos. 1-37; and a cultivation medium. In certain embodiments, the cultivation medium comprises Lysogeny broth.

Further provided is a method, product, or composition, as described herein, wherein the method, product, or composition is derived from a Pseudomonas fluorescens LE6D7 deposited as ATCC Accession No. PTA-127746.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A-1B: Petri plate assay demonstrating killing of the fish pathogen Saprolegnia parasitica by selective strains of Pseudomonas fluorescens. FIG. 1A shows hyphal plugs of Saprolegnia parasitica co-incubated with a microbial strain in 1 ml of distilled water for 3 h before transfer to a fresh plate of V8 agar. Regrowth of plugs labelled A12 and B12 indicate that those isolates allow regrowth of the oomycete and are therefore not useful biocontrol agents. Absence of growth on plugs labelled F11 indicates that hyphae are killed. FIG. 1B shows four strains of pseudomonads were effective in killing Saprolegnia hyphae.

FIG. 2: High through-put screen to identify antagonistic bacteria of pythium pathogens. Hyphal plugs were arrayed out on a fresh V8 agar plate and a 1 μl drop of a pseudomonad colony on a V8 plate was placed between rows. Strong antagonism is seen with a clearing zone surrounding where the bacteria was placed.

FIGS. 3A-3B: Competitive assay illustrating contact-dependent killing of specific pseudomonads.

FIG. 4: Contact-dependent killing of pythium isolates from Ohio Greenhouses. Hyphal plugs from rapidly growing pythium cultures on V8 plates were incubated with eight isolates from Ohio GHs. Each isolate was incubated with 1 ml of a suspension of the isolate strain LE6D7 for 27 h before transfer to a fresh V8 plate. Each plate contains six plugs that were incubates with a six-fold range of the biocontrol strain of the bacteria. In all cases no hyphal regrowth was noted at even the lowest initial concentration of 800 cfu/ml.

FIG. 5: Table 1, showing contact-dependent killing of Pythium strains with exposure to specific pseudomonads.

FIG. 6: Table 2, shows contact-dependent killing of 10 Pythium isolates from agricultural fields from Wood County, Ohio.

FIG. 7: Plasmid insertion into an operon results in loss of virulence. The vector pDONR1K18 ms containing flanking sequences of HCP1_05421 was electroporated into the Pseudomonas fluorescens isolate D7. Loss of virulence in transformants against two Pythium isolates labelled as W2 and W8 is shown on the two plates. The left side of the plate shows that the WT isolate blocks the growth of hyphae surrounding the bacterial colony. The right side of the plate shows that insertion of the plasmid into an operon results in loss of virulence allowing the hyphae to grow over and past the bacterial colonies, indicated by the ability of the hyphae to grow over and past the inoculation site of the bacteria.

FIG. 8: Table showing contact-dependent killing of oomycete pathogens by LE6D7.

FIG. 9: Filtration assay showing depletion of pythium propagules in a pythium contaminated hydroponic solution by P. fluorescens LE6D7.

FIG. 10: Map of northeast US showing approximate locations of pythium isolates obtained from commercial green houses (GHs).

FIGS. 11A-11B: Comparison of contact dependent killing of a pythium isolate by the biocontrol strains LE5G2 (FIG. 11A) and LE6D7 (FIG. 11B). There was no regrowth of hyphae from any of the plugs exposed to LE6D7 while hyphae regrowth occurred at five of the plugs exposed to the less aggressive isolate.

FIG. 12: Photograph showing contact-dependent killing of an environmental strain of Saprolegnia by LE6D7.

FIG. 13: Genetic organization of the T6SS₁ & T6SS₂ cluster in the P. fluorescens isolate LE6D7. Genes are represented as arrows indicating the direction of transcription. The color code of genes indicates their predicted role based on their homology to T6SS genes in P. aeruginosa PAO1. The architecture of this operon shows TssJLM as the membrane associated proteins that lie across the outer membrane and inner membrane. Next to the membrane proteins, the cluster encodes for proteins involved in sheath assembly with the help of TssK and needle component (Hcp1, VgrG, PAAR) which all are associated with the cytoplasm. T6SS₂ has 13 core genes. The architecture of this operon for T6SS₁ has 12 core genes and 2VgrG genes, however, this operon lacks Hcp gene within the operon.

FIG. 14: Model of the T6SS protein complex.

FIG. 15: Δhcp1LE6D7 results in loss of virulence against Pythium dissotocum. On the left, WT strain LE6D7 demonstrates contact dependent killing of 3 pythium isolates form commercial GHs. V8 agar plate was inoculated with 3 hyphal plugs of different pythium strains (A2, SP3, & SP2), and the pseudomonad was placed adjacent to the hyphal plug. At 24 h there is no growth of pythium in the direction adjacent to where the microbe was placed. On the right, Δhcp1LE6D7 knockout enables the hyphal mycelia to grow over the microbial colony, indicating a loss of virulence of the mutant strains against this host 24 h post inoculation.

FIG. 16: Loss of virulence in the Δvgrg_3601 mutant against Pythium strains Py1-Py6. Hyphal plugs (left: Py1-Py3) were placed on V8 media adjacent to WT (LHS) or KO (RHS) applied with a pipette tip. Pictures were taken after 16 h. In the case of WT, bacteria prevent egress of hyphae or spread quickly and killed hyphae. In the KOs, growth of hyphae sometimes overran the point of inoculation. Left plate: isolates Py1 to Py3; right plate: isolates Py4 to Py6.

FIG. 17: Phylogenetic characterization of TssB proteins in Pseudomonas fluorescens LE6_D7. Maximum likelihood tree with 1000 bootstrap replicates was constructed using MEGA 11 software. T6SS TssB phylogenetic analysis has been used to show major T6SS clusters. LE6_D7 TssBs falls into two groups: group 1.1 (purple) and group 4A (orange) together with TssBs from Pseudomonas fluorescens F113. TSSB proteins from P. putida, P. aeruginosa, and A. tumefaciens have been included in the construction of this tree to illustrate all the groups. The black dot (⋅) identifies the two TSSB sequences of LE6D7.

FIG. 18: SEM images of hyphae with and without bacteria co-incubation. On the upper left corner is the control, where the hyphae look healthy, smooth, and supple. The other three quadrants are treatment groups; these hyphae show signs of wrinkling, and some of the hyphae have burst open. Note the rounded structures contained within the intact hyphae.

### DETAILED DESCRIPTION

Throughout this disclosure, various publications, patents, and published patent specifications are referenced by an identifying citation. The disclosures of these publications, patents, and published patent specifications are hereby incorporated by reference into the present disclosure in their entirety to more fully describe the state of the art to which this invention pertains.

In accordance with the present disclosure, strains of pseudomonads isolated from algal blooms in Lake Erie are effective at killing oomycetes such as, but not limited to, Saprolegnia species and Pythium species. The pseudomonad strains include, but are not limited to, the Pseudomonas fluorescens strains LE6D7, LE6D8, LE6A6, LE6A8, LE5F1, LE5F7, LE5F8, LE5G2, LE5G8, and LE5H2. The killing is contact-dependent. The Pseudomonas strains are therefore useful for a wide variety of application, such as protecting fish eggs against Saprolegnia species, and as biocontrol agents for protecting plants against Pythium species. Whereas it was previously known that certain pseudomonads were capable of inhibiting growth of oomycetes, the pseudomonad strains described herein are capable of killing oomycetes.

Each of the Pseudomonas fluorescens strains LE6D7, LE6D8, LE6A6, LE6A8, LE5F1, LE5F7, LE5F8, LE5G2, LE5G8, and LE5H2 were isolated from algal blooms in Lake Erie. In particular, these strains were collected at the GPS coordinates of 41°55′00″N, 81°31′00″W in February of 2012. These particular Pseudomonas fluorescens strains are encompassed by those described in the article entitled Aquatic Pseudomonads Inhibit Oomycete Plant Pathogens of Glycine max, by Andrew Wagner, et al., FRONT. MICROBIOL. 9:1007 (May 2018), which is incorporated herein by reference for all purposes. The LE6D7 strain is deposited as ATCC Accession Number PTA-127746. Each of the strains LE6A6 and LE6D7 is also mentioned in, for example, the thesis entitled “Elucidating Factors Influencing Chytrip Parasitism on Several Strains of Green Alga Scenedesmus” by Fiona Harrigian. The strain LE6D8 is also mentioned in the thesis entitled “Environmental Pseudomonas are a Source of Novel Antibiotics that Inhibit Cystic Fibrosis Derived Pathogenic Pseudomonas Aeruginosa” by Payel Chatterjee. Thus, the Pseudomonas fluorescens strains described herein are known. Moreover, the strains may be collected from algae blooms in Lake Erie. As demonstrated in the examples herein, the bacterial strains may be used to kill oomycetes. In some embodiments, the bacterial strains or active variants thereof can be used to reduce, or reduce the content of, an oomycete around plants in an agricultural environment.

Without wishing to be bound by theory, it is believed that the mechanism of action through which the pseudomonads kill the oomycetes relies on the type VI secretion system (T6SS), which is a sort of nano-crossbow that is embedded in the bacterial membrane. Thus, provided herein is the use of an organism having the T6SS to kill oomycetes. T6SSs are found in more than 25% of gram-negative bacteria and are used by bacteria to inject proteins into prokaryotic and eukaryotic cells to promote pathogenesis or inhibit host defense responses. In the field of host-pathogen interactors, effector proteins are those group of proteins that are secreted by the pathogen and are designed to manipulate host physiological activities to promote pathogenesis. These activities can include: export of nutrients from the host, inhibition of an innate immune response, or triggering cell death. This protein machine of 13 different proteins fires a hollow shaft consisting of Hcp1 proteins that house additional effector proteins within the shaft. Additional VgrG (Valine-glycine repeat protein G) containing proteins form the arrow spike with an additional tip provided by Proline-Alanine-Alanine-Arginine (PAAR) domain-containing proteins. When the hollow arrow is fired into the host cytoplasm, the arrow proteins disassociate, releasing the effector proteins, which direct the outcome of the pathogen-host interaction, by blocking cell defense systems, facilitating export of nutrients, triggering a cell death response, etc. These three proteins enable the delivery of other proteins named cargo effectors into the host cell. Binding of these proteins to HCP1, VgrG, or PAAR can be direct, or facilitated by additional adaptor proteins. VgrG proteins may also have toxin domains integrated in the protein. Pseudomonas isolates have been described that utilize T6SS to kill bacterial, amoeba, plant, animal, and most recently fungal hosts, but no examples are known of pseudomonad-oomycete interactions. The timing and delivery of effectors once the attack has initiated may also be important. The biocontrol strain LE6D7 has four hep genes that are differentially regulated as well as four PaAR gene and 12 VgrG type proteins. Thus, this strain is capable of delivering a considerable diversity of effectors into the host cytoplasm. As shown in the examples herein, a loss of virulence against oomycetes in these strains is observed when the T6SS is knocked out of the organisms, confirming that the T6SS is responsible for killing. Thus, the methods described herein are distinct from administering an antibiotic into the environment, because the mechanism of action involves injecting proteins into the oomycetes through the T6SS of the Pseudomonad organisms. The injected proteins disable the host oomycetes.

The proteins involved in the T6SS systems of the Pseudomonas strains described herein include SEQ ID Nos. 1-37. Thus, provided herein is the use of one or more organisms having a T6SS system characterized by the presence of any of SEQ ID Nos. 1-37, or a sequence having at least about 90% sequence identity to any of SEQ ID Nos. 1-37, to kill oomycetes. Moreover, the T6SS systems of certain of the Pseudomonas strains having the killing activity against oomycetes secrete SEQ ID Nos. 1-7. Thus, provided herein is the use of an organism having a T6SS which secretes at least one of SEQ ID Nos. 1-7 to kill oomycetes. Organisms having a T6SS which secretes at least one of SEQ ID Nos. 1-7 may be useful for killing oomycetes. Organisms having a T6SS which secretes each of SEQ ID Nos. 1-7 are especially useful for killing oomycetes.

Motility is also an important consideration. When added to a hydroponic system, for example, the organisms described herein may land on the biofilm and move across the biofilm to ensure killing of all oomycetes present. The Pseudomonas strains described herein exhibit sufficient motility to kill oomycetes in this manner.

Provided are compositions and methods involving one, or a combination of two or more, of a strain of pseudomonad useful for killing oomycetes, where the strain of pseudomonad may or may not be a genetically altered variant. The strains may be used individually or combined in a mixture. Such compositions may further include any conventional inactive ingredients or additives for a biocontrol formulation such as, but not limited to, solvents, emulsifiers, surfactants, stabilizers, colorants, and fragrances. Solvents are liquids useful for dissolving the active ingredients and that allow for easy application of the composition as, for instance, a biocontrol agent. Common solvents include, but are not limited to, water, ethanol, and hydrocarbons. Emulsifiers are substances that help to fix the active ingredients with the solvent(s), and are useful to ensure that the active ingredients are evenly dispersed and can be applied uniformly. Surfactants are compounds that help to reduce the surface tension of liquids, allowing them to spread more easily. Surfactants may be used, for instance, to help a solution stick to a plant surface and penetrate the plant tissues. Stabilizers are substances which prevent the active ingredients from breaking down or degrading over time. Stabilizers may be used to ensure that the product remains effective throughout its shelf life. Fragrances may be added to improve odor and make the composition more pleasant to use.

In one non-limiting example, provided herein is a biocontrol composition that can be applied to hydroponic water where the biocontrol composition includes one or more organisms having a T6SS which secretes any of SEQ ID Nos. 1-7. In some examples, the biocontrol composition includes one or more of Pseudomonas fluorescens strains LE6D7, LE6D8, LE6A6, LE6A8, LE5F1, LE5F7, LE5F8, LE5G2, LE5G8, or LE5H2 at a concentration sufficient to cleanse the hydroponic system of Pythium propagules, since the pseudomonad strains exhibit contact-dependent killing of these pathogens. The pseudomonad strains described herein can be grown in culture and applied to contaminated hydroponic systems specifically to kill these pathogens. Thus, these organisms can be employed to rid a hydroponic system of these pathogens.

As used herein, the term “isolated” includes a bacterium, spore, or other object or substance that (1) has been isolated from at least some of the components with which it was initially associated (in nature or in an experimental setting) and/or (2) obtained, prepared, refined and/or handcrafted by humans. Isolated bacteria can be separated from at least about 10%, about 20%, about 30%, about 40%, about 50%, about 60%, about 70%, about 80%, about 90%, or more other components by which it was originally bound.

When used in the present disclosure, a substance is “pure” if it is substantially free of other components. The term “purified” refers a bacterium, spore, or other material that has been isolated from at least some of the components with which it was associated or when it was originally obtained or formed (for example, in nature or experimental setup), or some time after it was originally received. A bacterium, spore, or bacterial population or spore population may be considered purified if it is isolated during or after being obtained, for example, from a material or medium containing a bacterium or a bacterial or spore population, and the purified bacterium or a bacterial or spore population may contain other materials in an amount of up to about 10%, about 20%, about 30%, about 40%, about 50%, about 60%, about 70%, about 80%, about 90%, or more than about 90% is still considered purified. In some embodiments, purified bacteria or spores and bacterial populations or spore populations have a purity of greater than about 80%, about 85%, about 90%, about 91%, about 92%, about 93%, about 94%, about 95%, about 96%, about 97%, about 98%, about 99%, or more than about 99%. In preferred embodiments, the bacterial culture does not contain other bacterial species in amounts that are detectable by conventional bacteriological techniques.

“Modified bacterial strain” means a population in which the strain has been modified (by selection and/or transformation) to impart one or more additional traits of interest. A modified bacterial strain may be compatible with biocides such as, but not limited to, herbicides, fungicides, pesticides, or other plant protection chemical resistance. The modified biocide-resistant strains have the same identifying characteristics as the original susceptible strains, with the difference that they are significantly more resistant to a particular herbicide, fungicide, pesticide, or other plant protection chemical. Their identification is easy to carry out by comparison with the characteristics of a known susceptible strain. Thus, the present disclosure relates to isolated populations of modified bacterial strains.

The term “population” means a group or set that includes two or more elements (ie, 10, 100, 1000, 10000, 1×10⁶, 1×10⁷, or 1×10⁸, or more). The present disclosure provides various compositions that include a population of at least one bacterial strain. In preferred embodiments, a population of at least one of the bacterial strains (i.e., Pseudomonas fluorescens strains LE6D7, LE6D8, LE6A6, LE6A8, LE5F1, LE5F7, LE5F8, LE5G2, LE5G8, or LE5H2), or an active variant of any of them, or a spore or prespore, or a combination of cells, includes a concentration of at least about 10⁵ cfu/ml to about 10¹¹ cfu/ml, about 10⁵ cfu/ml to about 10¹⁰ cfu/ml, about 10⁵ cfu/ml to about 10¹² cfu/ml, about 10⁵ cfu/ml to about 10⁶ cfu/ml, from about 10⁶ cfu/ml to about 10⁷ cfu/ml, from about 10⁷ cfu/ml to about 10⁸ cfu/ml, from about 10⁸ cfu/ml to about 10⁹ cfu/ml, from about 10⁹ cfu/ml to about 10¹⁰ cfu/ml, from about 10¹⁰ cfu/ml to about 10¹¹ cfu/ml, or from about 10¹¹ cfu/ml to about 10¹² cfu/ml. In other embodiments, the concentration of a bacterial strain of the present disclosure or an active variant thereof comprises at least about 10⁵ cfu/ml, at least about 10⁶ cfu/ml, at least about 10⁷ cfu/ml, according to at least about 10⁸ cfu/ml, at least about 10⁹ cfu/ml, at least about 10¹⁰ cfu/ml, at least about 10¹¹ cfu/ml, or at least about 10¹² cfu/ml.

“Spore” means at least one resting (when applied) but viable reproductive unit of a bacterial species. The spores may be prepared from any of Pseudomonas fluorescens strains LE6D7, LE6D8, LE6A6, LE6A8, LESF1, LE5F7, LE5F8, LE5G2, LE5G8, or LE5H2 (or variants of any of them) through known methods. It should also be noted that the populations disclosed in the present disclosure may include a combination of non-spore cells and prespores (cells at an intermediate stage of spore formation); or a combination of prespores, non-spore cells, and/or spores.

Compositions comprising a bacterial strain (i.e., at least one of Pseudomonas fluorescens strains LE6D7, LE6D8, LE6A6, LE6A8, LE5F1, LE5F7, LE5F8, LE5G2, LE5G8, or LE5H2, or an active variant of any of them, or a spore or prospore, or a combination of cells, prespores and/or a spore of any of Pseudomonas fluorescens strains LE6D7, LE6D8, LE6A6, LE6A8, LE5F1, LE5F7, LE5F8, LE5G2, LE5G8, or LE5H2, or an active variant of any of them) may further comprise an agriculturally acceptable carrier. The term “agriculturally acceptable carrier” includes any material that facilitates application of the composition to an intended object (i.e., a plant or plant part susceptible to a plant disease of interest), or to a plant or plant part to improve an agricultural trait of interest). Carriers used in compositions for application to plants and plant parts are preferably non-phytotoxic or only slightly phytotoxic. A suitable carrier may be solid, liquid, or gaseous depending on the formulation desired. In some embodiments, carriers include polar or non-polar liquid carriers such as water, mineral oils, and vegetable oils. Additional carriers are possible and encompasse within the scope of the present disclosure.

Preparations or forms for applying various bacterial strains or active variants thereof may include, but are not limited to, excipients such as bulking agents, solvents, spontaneous stimulants, carriers, emulsifiers, dispersing agents, antifreeze agents, biocides, solid carriers, surfactants, thickeners, and/or other auxiliary substances such as adjuvants. An adjuvant in this context is a component that enhances the biological effect of a drug without the component itself having a biological effect. Examples of adjuvants are agents that promote retention, distribution, adhesion to a surface, or penetration.

The biocontrol compositions may include a cultivation medium. The cultivation medium is a substance or mixture of substances used to support the growth and proliferation of the Pseudomonas organism(s) in the compositions, providing nutrients. In some examples, the cultivation medium is standard Lysogeny broth (LB) media.

Non-limiting examples of bulking agents are, for example, water, polar and non-polar organic chemical liquids, for example, from the classes of aromatic and non-aromatic hydrocarbons (such as paraffins, alkylbenzenes, alkylnaphthalenes, chlorobenzenes), alcohols and polyols (which, if necessary, can also be substituted, converted to ethers and/or esters), ketones (such as acetone, cyclohexanone), esters (including fats and oils), and ethers (poly) ethers, unsubstituted and substituted amines, amides, lactams (such as N-alkylpyrrolidones) and lactones, and sulfones and sulfoxides (such as dimethyl sulfoxide). If the bulking agent used is water, it is also possible to use, for example, organic solvents as auxiliary solvents. Non-limiting examples of liquid solvents are: aromatic compounds such as xylene, toluene or alkyl naphthalenes, chlorinated aromatics and chlorinated aliphatic hydrocarbons such as chlorobenzenes, chloroethylenes or methylene chloride, aliphatic hydrocarbons such as cyclohexane or mineral paraffins, for example, petroleum fractions, vegetable oils, alcohols such as butanol or glycol and also their ethers and esters, ketones such as acetone, methyl ethyl ketone, methyl isobutyl ketone or cyclohexanone, strongly polar solvents such as dimethylformamide and dimethyl sulfoxide and also water. In principle, any suitable solvent can be used. Non-limiting examples of solvents are, for example, aromatic hydrocarbons such as xylene, toluene or alkylnaphthalenes, for example chlorinated aromatic or aliphatic hydrocarbons such as chlorobenzene, chloroethylene or methylene chloride, for example aliphatic hydrocarbons such as cyclohexane, for example, paraffins, petroleum fractions, mineral and vegetable oils, alcohols such as methanol, ethanol, isopropanol, butanol or glycol, for example and also their ethers and esters, ketones such as acetone, methyl ethyl ketone, methyl isobutyl ketone or cyclohexanone, for example strongly polar solvents such as dimethyl sulfoxide and water.

Non-limiting examples of suitable carriers include, for example, ammonium salts and particulate natural minerals such as kaolins, clays, talc, chalk, quartz, attapulgite, montmorillonite, or diatomaceous earth, and particulate synthetic minerals such as micronized silica, alumina, and natural, or synthetic silicates, resins, waxes, and/or solid fertilizers. A mixture of such carriers may also be used. Carriers suitable for granules include the following: for example, crushed and fractionated natural minerals such as calcite, marble, pumice, sepiolite, dolomite, and also synthetic granules of inorganic and organic flour, and also granules of their organic material such as sawdust, paper, coconut shells, corn cobs, and tobacco leaf stalks.

Liquefied gaseous bulking agents or solvents may also be used. Non-limiting examples are those bulking agents or carriers that are gaseous at normal temperature and pressure, examples are aerosol propellants such as halogenated hydrocarbons, and also butane, propane, nitrogen and carbon dioxide. Examples of emulsifiers and/or foaming agents, dispersants or wetting agents with ionic or non-ionic characteristics, or mixtures of these surfactants, are polyacrylic acid salts, lignosulfonic acid salts, phenolsulfonic acid or naphthalenesulfonic acid salts, ethylene oxide polycondensates with fatty alcohols fatty acids or fatty amines, with substituted phenols (preferably alkyl phenols or aryl phenols), sulfosuccinic acid ester salts, taurine derivatives (preferably alkyl taurates), polyethoxylated alcohols or phenol phosphates, fatty acid and polyol esters and derivatives of compounds containing sulfates, sulfonates and phosphates, examples are alkylaryl polyglycol ethers, alkyl sulfonates, alkyl sulfates, arylsulfonates, protein hydrolysates, lignin sulfite waste solutions, and methyl cellulose. The presence of a surfactant is beneficial if one of the active compounds and/or one of the inert carriers is insoluble in water and if the application is carried out in water.

Other auxiliary substances which may be contained in the preparations and in the application forms formed therefrom include coloring agents such as inorganic pigments, examples are iron oxide, titanium oxide, Prussian blue, and organic dyes such as alizarin dyes, azo dyes, and metal phthalocyanine dyes, and nutrients and micronutrients such as salts of iron, manganese, bol, copper, cobalt, molybdenum, and zinc.

Stabilizers such as low temperature stabilizers, preservatives, antioxidants, light stabilizers, or other agents that increase chemical and/or physical stability may also be included in the biocontrol compositions described herein. In addition, foaming agents or antifoam agents may be present.

In addition, the preparations and the application forms formed therefrom may also include, as additional auxiliary substances, adhesives such as carboxymethyl cellulose, natural and synthetic polymers in powder, granular or latex form such as gum arabic, polyvinyl alcohol, polyvinyl acetate and also natural phospholipids such as cephalins and lecithins, and synthetic phospholipids. Other possible excipients include mineral and vegetable oils.

Other excipients may also be contained in the biocontrol compositions. Examples of such additives include fragrances, protective colloids, binders, adhesives, thickeners, thixotropic agents, permeation agents, retention aids, stabilizers, sequestrants, complexing agents, humectants, and dispensing agents. In general, the bacterial strains described herein can be combined with any solid or liquid additive commonly used in the preparation of biocontrol formulations.

Suitable retention stimulants may also be present and may include substances that reduce surface tension dynamics, such as dioctyl sulfosuccinate or increase viscoelasticity, such as, for example, hydroxypropyl guar polymers.

Suitable penetration agents for inclusion in the biocontrol composition may include all such substances which are commonly used to increase the penetration of active agrochemical compounds into plants. Permeation agents are defined in this context so that from the (usually aqueous) application liquid and/or from the spray coating they can penetrate the cuticle of the plant and increase the mobility of the active agents in the cuticle. Examples include alcohol alkoxylates such as coconut fatty acid ethoxylates, fatty acid esters such as rapeseed or soybean fatty acid methyl esters, fatty amine alkoxylates such as tallowamine ethoxylate, or ammonium and/or phosphonium salts, such as, for example, ammonium sulfate or ammonium dihydrogen phosphate.

The biocontrol compositions herein may contain an effective amount of a bacterial strain such as any of Pseudomonas fluorescens strains LE6D7, LE6D8, LE6A6, LE6A8, LE5F1, LE5F7, LE5F8, LE5G2, LE5G8, or LE5H2, or an active variant of any of them, or a spore or prespore, or a combination cells, prespores, and/or spores of any of Pseudomonas fluorescens strains LE6D7, LE6D8, LE6A6, LE6A8, LE5F1, LE5F7, LE5F8, LE5G2, LE5G8, or LE5H2 (or variants of any of them). Such an amount may have a bacterial strain concentration of at least about 10⁴ to about 10¹¹, at least about 10⁵ CFU/g to about 10¹¹ CFU/g, from about 10⁵ CFU/g to about 10¹⁰ CFU/g, or from about 10¹¹ CFU/g to about 10¹² CFU/g. In other embodiments, the concentration of the bacterial strain comprises at least about 10⁵ CFU/g, at least about 10⁶ CFU/g, at least about 10⁷ CFU/g, at least about 10⁸ CFU/g, by at least about 10⁹ CFU/g, at least about 10¹⁰ CFU/g, at least about 10¹¹ CFU/g, at least about 10¹² CFU/g, at least about 10⁴ CFU/g. Such concentrations of the bacterial strain can be in any formulation of the type of interest, including, for example, a wettable powder, a spray dried formulation, or cell mass.

Cell masses and wettable powders and spray dried preparations may include a bacterial strain such as any of Pseudomonas fluorescens strains LE6D7, LE6D8, LE6A6, LE6A8, LE5F1, LE5F7, LE5F8, LE5G2, LE5G8, or LE5H2, or an active variant of any of them. The amount of bacterial strain may have a bacterial strain concentration of at least about 10⁵ CFU/g to about 10¹¹ CFU/g, from about 10⁷ CFU/g to about 10¹⁰ CFU/g, from about 10⁷ CFU/g to about 10¹⁰ CFU/g, from about 10⁸ CFU/g to about 10¹¹ CFU/g, from about 10¹⁰ CFU/g to about 10¹¹ CFU/g, from about 10¹⁰ CFU/g to about 10¹² CFU/g, from about 10⁵ CFU/g to about 10¹⁰ CFU/g, from about 10⁵ CFU/g to about 10¹⁰ CFU/g, from about 10⁵ CFU/g to about 10¹² CFU/g, from about 10⁶ CFU/g to about 10⁷ CFU/g, from about 10⁷ CFU/g to about 10⁸ CFU/g, from about 10⁸ CFU/g to about 10⁹ CFU/g, from about 10⁹ CFU/g to about 10¹⁰ CFU/g, from about 10¹⁰ CFU/g to about 10¹¹ CFU/g, or from about 10¹¹ CFU/g to about 10¹² CFU/g. In some embodiments, the concentration of the bacterial strain comprises at least about 10⁵ CFU/g, at least about 10⁶ CFU/g, at least about 10⁷ CFU/g, at least about 10⁸ CFU/g, by at least about 10⁹ CFU/g, at least about 10¹⁰ CFU/g, at least about 10¹¹ CFU/g, at least about 10¹² CFU/g, or at least about 10¹³ CFU/g.

The preparations preferably contain from 0.00000001% to 98% by weight of bacteria, or particularly preferably from 0.01% to 95% by weight of bacteria, more preferably from 0.5% to 90% by weight of bacteria.

In addition, any of the bacterial strains described herein, or active variants thereof, can be mixed with a biocide such as a fungicide, insecticide, or herbicide to increase its activity or the activity of the chemical to which it is added. In some cases, a combination of a bacterial strain and a chemical may have synergistic activity when the mixture of the two systems has an activity that exceeds the expected simple additive activity.

In some embodiments, the bacterial strains or active variants thereof are compatible with agricultural chemicals used to improve the performance of biocides. Such agricultural chemicals include safeners, surfactants, adhesives, dispensers, UV protection agents, and suspending and dispersing agents. Antidotes are chemicals that improve or modify the characteristics of herbicides. Surfactants, spreading agents and adhesives are chemicals included in agricultural spray formulations that alter the mechanical characteristics of the spray formulation (for example, by changing the surface tension or increasing cuticle permeability). UV protection products improve the performance of agricultural biocides by reducing UV degradation. Suspending and dispersing agents improve the performance of biocides by modifying their properties in the spray tank. In cases where the bacterial strain or active variant is incompatible with the agricultural chemical of interest, if desired, the methods can be used to modify the bacterial strain to render the compatibility of interest. Such methods of obtaining modified bacterial strains include selection techniques and/or transformation techniques.

Non-limiting examples of additional compounds that can be added to a biocontrol composition described herein include, but are not limited to, acetyltributyl citrate [2-(acetyloxy) citric acid tributyl ester]; agar; almond shell; almond husks; alpha cyclodextrin; aluminosilicate; magnesium aluminum silicate [aluminum magnesium salt of silicic acid]; aluminum-potassium-sodium silicate [aluminum-potassium-sodium salt of silicic acid]; aluminum silicate; sodium aluminosilicate [aluminum-sodium salt of silicic acid]; sodium aluminosilicate (1:1:1) [aluminum-sodium salt of silicic acid (H₄SiO₄) (1:1:1)]; ammonium benzoate [ammonium salt of benzoic acid]; ammonium stearate [octadecanoic acid ammonium salt]; amylopectin, acid hydrolyzed 1-octenylbutanedioate; amylopectin, hydro-1-octadecenyl butanedioate; bone glue; ascorbyl palmitate; clay of attapulgite type; beeswax; bentonite; sodium derivative of bentonite; beta cyclodextrin; bone flour; bran; breadcrumbs; (+)-butyl lactate; [(S)-lactic acid n-butyl ester]; butyl lactate [n-butyl lactic acid ester]; butyl stearate [octadecanoic acid butyl ester]; lime slate; calcite (Ca(CO₃)); calcium acetate; calcium acetate monohydrate [acetic acid calcium salt monohydrate]; calcium benzoate [calcium salt of benzoic acid]; calcium carbonate; calcium citrate [calcium citric acid]; calcium octanoate; calcium oxide silicate; calcium silicate [calcium silicic acid]; calcium stearate [calcium salt of octadecanoic acid]; calcium sulfate; calcium sulfate dihydrate; calcium sulfate hemihydrate; canary seed; coal; carbon dioxide; carboxymethyl cellulose [carboxymethyl cellulose ether]; cardboard; carnauba wax; ceratonia leguminous gum [locust bean gum]; carrageenan; caseins; Castor oil; hydrogenated castor oil; cat canned food; cellulose; cellulose acetate; sodium salt of cellulose, a mixture with carboxymethyl cellulose ether; cellulose pulp; regenerated cellulose; cheese; chlorophyll a; chlorophyll b; citrus flour; lemon acid; citric acid monohydrate; citrus pectin; citrus pulp; shells of molluscs; cocoa; cocoa husk flour; cocoa husk; cod liver oil; coffee grounds; cookies; bung; corn cobs; cotton; cottonseed meal; ground wheat groats; monoester of decanoic acid with 1,2,3-propanetriol; dextrins; diglyceryl monooleate [ester of 9-octadecenoic acid with 1,2,3-propanetriol]; diglyceryl monostearate [9-octadecanoic acid monoester with bis(propanediol)]; dilaurin [dodecanoic acid diester with 1,2,3-propanetriol]; dipalmitin [diester of hexadecanoic acid with 1,2,3-propanetriol]; dipotassium citrate [dipotassium citric acid]; disodium citrate [disodium citric acid]; disodium sulfate decahydrate; diatomaceous earth (less than 1% crystalline silicon dioxide); monoester of dodecanoic acid with 1,2,3-propanetriol; dolomite; douglas bark; eggshell; eggs; (+) ethyl lactate [ethyl ester of(S)-lactic acid]; ethyl lactate [ethyl ester of lactic acid]; feldspar; fish flour; fish oil; Fuller's earth; fumaric acid; gamma cyclodextrin; gelatins; gellan gum; gluc (in the form of depolymerized animal collagen); glycerol [1,2,3-propanetriol]; glycerol monooleate [(Z)-9-octadecenoic acid 2,3-dihydroxypropyl ester]; glyceryl dicaprylate [octanoic acid diester with 1,2,3-propanetriol]; glyceryl dimyristate [tetradecanoic acid diester with 1,2,3-propanetriol]; glyceryl dioleate [(9Z)-9-octadecenoic acid diester with 1,2,3-propanetriol]; glyceryl distearate; glyceryl monomyristate [tetradecanoic acid monoester with 1,2,3-propanetriol]; glyceryl monooctanoate [octanoic acid monoester with 1,2,3-propanetriol]; glyceryl monooleate [(9Z)-9-octadecenoic acid monoester with 1,2,3-propanetriol]; glyceryl monostearate [octadecanoic acid monoester with 1,2,3-propanetriol]; glyceryl stearate [octadecanoic acid ester with 1,2,3-propanetriol]; granite; guar gum; gum arabic; tragacanth gum; gypsum; hematite (Fe₂O₃); humic acid; hydrogenated cottonseed oil; hydrogenated rapeseed oil; hydrogenated soybean oil; hydroxyethyl cellulose [2-hydroxyethyl cellulose ether]; hydroxypropyl cellulose [2-hydroxypropyl cellulose ether]; hydroxypropyl methyl cellulose [2-hydroxypropyl methyl cellulose ether]; iron oxide magnesium (Fe₂MgO₄); iron oxide (Fe₂O₃); iron oxide (Fe₂O₃); iron oxide (Fe₃O₄); iron oxide (FeO); isopropyl alcohol [2-propanol]; isopropyl myristate; kaolin; lactose; lactose monohydrate; lanolin; latex rubber; lauric acid; lecithins; extract from licorice root; lime (chemical) dolomite; limestone; linseed oil; magnesium carbonate [magnesium salt of carbonic acid (1:1); magnesium benzoate; magnesium oxide; magnesium oxide-silicate monohydrate (Mg₃O(Si₂O₅)₂); magnesium silicate; magnesium silicate hydrate; magnesium oxide-silicon (Mg₂Si₃O₈); magnesium stearate [octadecanoic acid magnesium salt]; magnesium sulfate; magnesium sulfate heptahydrate; Apple acid; malt extract; malt flour; maltodextrin; methylcellulose [cellulose methyl ether]; mica; minerals of the mica group; milk; N/A millet flour; mineral oil (USP); 1-monolaurin [2,3-dihydroxypropyl dodecanoic acid ester]; 1-Monomyristine [2,3-dihydroxypropyl tetradecanoic acid ester]; monomyristine [decanoic acid diester with 1,2,3-propanetriol]; monomalmitin [monoester of hexadecanoic acid with 1,2,3-propanetriol]; potassium monocitrate [monopotassium salt of citric acid; sodium monocitrate [monosodium citric acid]; montmorillonite; myristic acid; nepheline syenite; nitrogen; nutria meat; nylon; potassium salt of octanoic acid; sodium salt of octanoic acid; almond oil; wheatgrass oil; oleic acid; oyster shells; Palm oil; hydrogenated palm oil; palmitic acid [hexadecanoic acid]; paraffin wax; peanut butter; peanut shells; peanut; sphagnum; pectin; perlite; expanded perlite; gypsum; polyethylene; polyglyceryl oleate; polyglyceryl stearate; potassium acetate [potassium salt of acetic acid]; anhydrous aluminosilicate; potassium benzoate [potassium salt of benzoic acid]; potassium bicarbonate [monopotassium salt of carbonic acid]; potassium chloride; potassium citrate [potassium salt of citric acid]; potassium humate [potassium salts of humic acids]; potassium myristate potassium salt [tetradecanoic acid]; potassium oleate [(9Z)-9-octadecenoic acid potassium salt; potassium ricinoleate [12-hydroxy-(9Z,12R)-9-octadecenoic acid monopotassium salt]; potassium sorbate [potassium salt of sorbic acid]; potassium stearate [potassium salt of octadecanoic acid]; potassium sulfate; potassium sulfate [monopotassium salt of sulfuric acid]; 1,2-propylene carbonate [4-methyl-1,3-dioxolan-2-one]; pumice; red cabbage pigment (obtained from edible red cabbage heads by pressing using only acidified water); wood chips of virginian juniper; feed meal; rubber; sawdust; slate; amorphous fumed silica (crystal free); amorphous precipitated silica and gel; silicon dioxide (crystal free); silica gel; precipitated silica gel without crystals; hydrate of silicon dioxide; glassy silicon dioxide; magnesium salt of silicic acid (H₂SiO₃) (1:1); soap (water-soluble sodium or potassium salts of fatty acids obtained by saponification of fats and oils or by neutralization of fatty acids); kilaya [kilaya saponin]; talc; sodium acetate [sodium salt of acetic acid]; sodium alginate; sodium benzoate [sodium benzoic acid]; bicarbonate of soda; sodium salt of carboxymethyl cellulose [sodium salt of carboxymethyl cellulose ether]; sodium chloride; sodium citrate; sodium humate [sodium salts of humic acids]; sodium oleate; sodium ricinoleate [(9Z,12R)-12-hydroxy-9-octadecenoic acid monosodium salt]; sodium stearate [sodium salt of octadecanoic acid]; sodium sulfate; sorbitol [D-glucite]; soy protein; soy lecithins [soy lecithins]; soybean husks; soybean meal; soy flour; stearic acid [octadecanoic acid]; sulfur; syrups, hydrogenated hydrolyzed starch; tetraglyceryl monooleate [(9Z)-9-octadecenoic acid monoester with tetraglycerol]; calcium tricitrate [calcium citric acid (2:3)]; triethyl citrate [triethyl citric acid; potassium tricitrate tripotassium salt [citric acid]; potassium tricitrate monohydrate [citric acid tripotassium salt monohydrate]; trisodium citrate [citric acid trisodium salt]; trisodium citrate dihydrate [trisodium citric acid dihydrate]; trisodium citrate pentahydrate [trisodium citrate pentahydrate]; ultramarine blue [CI Pigment Blue 29]; urea; vanillin; vermiculite; wine vinegar (in a solution of no more than 8% acetic acid); vitamin C [L-ascorbic acid]; vitamin; walnut shell flour; walnut shells; wheat; Wheat flour; wheat germ oil; serum; light mineral oil (petroleum); wintergreen oil; wollastonite (Ca(SiO₃)); wool; xanthan gum; yeast; zeolites (excluding eriocyte (CAS Reg. No. 66733-21-9)); zeolites NaA; zinc iron oxide; zinc oxide (ZnO); and zinc stearate [octadecanoic acid zinc salt].

The biocontrol compositions described herein are useful in a wide variety of possible environments or situations. As two non-limiting examples, the biocontrol compositions are useful in hydroponic systems and in fish hatcheries.

Hydroponic systems offer numerous advantages for crop production, including precise control over nutrient delivery and environmental conditions. However, hydroponic systems are susceptible to infestations by oomycetes, such as Pythium species, which can cause devastating losses in crop yield and quality. The biocontrol compositions described herein (containing one or more organisms having a T6SS system which secretes any of SEQ ID Nos. 1-7, and/or is characterized by any of SEQ ID Nos. 1-37 or a sequence having at least about 90% sequence identity to any of SEQ ID Nos. 1-37) can be applied to hydroponic systems at various stages of plant growth, including during system establishment, transplanting, and throughout the cropping cycle. Application methods may include, but are not limited to, foliar sprays, root drenches, or incorporation into the nutrient solution. Upon application, the biocontrol composition may establish a protective barrier around plant roots and foliage, preventing oomycete ingress and colonization. In this manner, by integrating the biocontrol composition into their cultivation practices, growers can mitigate the risks associate with oomycete infestations, leading to improved crop productivity, quality, and sustainability.

As another example, the biocontrol compositions offer a solution for protecting fish eggs from oomycete infections in aquaculture settings. The biocontrol composition may be contacted to fish eggs. In some non-limiting examples, the fish eggs belong to at least one family selected from: Salmonidae, Cyprinidae, Chanidae, Cichlidae, or Siluridae. The fish eggs may be a population comprising at least one of: salmon, trout, carp, koi, milkfish, tilapia, or catfish. In some non-limiting examples, the fish eggs are a population of no more than one or two species. The fish eggs may be in an enclosure, such as a hatchery pond, tank, pool, or aquarium. In such cases, the biocontrol composition may be added to a fluid in the enclosure.

Oomycetes pose a significant threat to fish hatcheries and aquaculture facilities, where they can cause high mortality rates among fish embryos and larvae. By incorporating the biocontrol composition into fish hatcheries and spawning grounds, aquaculturists can create a protective environment for fish eggs. This not only safeguards the viability of fish populations but also reduces the reliance on chemical treatments, thereby promoting environmentally sustainable aquaculture practices.

### EXAMPLES

The Pseudomonas fluorescens strains used in these examples were isolated from the Lake Erie Central Basin, Station 880, at the coordinates 41°55′00″N, 81°31′00″W, in February of 2012. The Pseudomonas fluorescens strains are among those described as having been collected (even though not mentioned by name) in the article entitled Aquatic Pseudomonads Inhibit Oomycete Plant Pathogens of Glycine max, by Andrew Wagner, et al., FRONT. MICROBIOL. 9:1007 (May 2018), which is incorporated herein by reference for all purposes.

### Example 1—Petri Plate Assay

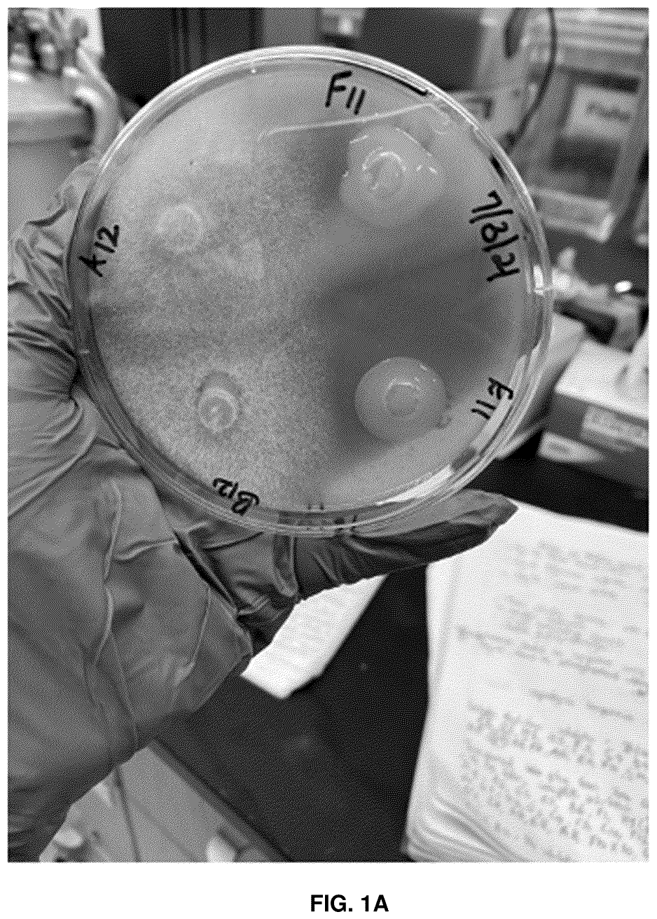

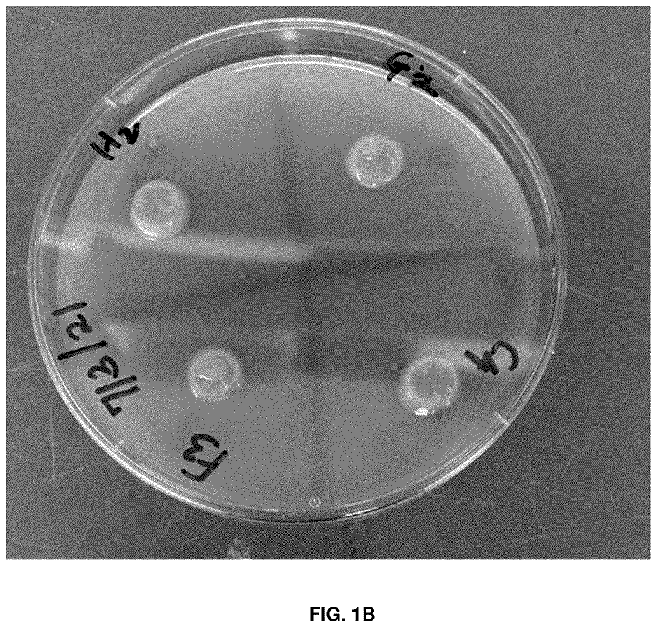

A petri plate assay was conducted, and demonstrated killing of the fish pathogen Saprolegnia parasitica by selective strains of Pseudomonas fluorescens. FIGS. 1A-1B show the results. Hyphal plugs of Saprolegnia parasitica were co-incubated with a microbial strain in 1 ml of distilled water for 3 h before transfer to a fresh plate of V8 agar. (FIG. 1A.) Regrowth of plugs labelled A12 and B12 indicate that those isolates allow regrowth of the oomycete and are therefore not useful biocontrol agents. Absence of growth on plugs labelled F11 indicates that hyphae are killed. Four strains of pseudomonads were shown to be effective in killing Saprolegnia hyphae. (FIG. 1B.)

### Example 2—Microbial Strains and Methods of Culturing

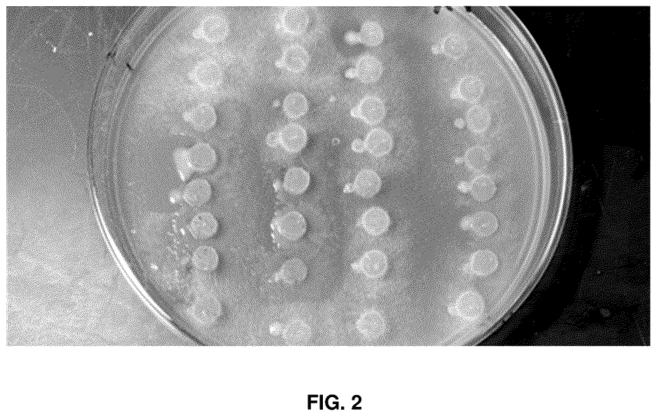

Pythium strains were cultured on V8 agar media. Pseudomonad strains were cultured overnight in LB media. To identify antagonistic bacteria strains, 3 mm agar plugs from a rapidly growing culture were arrayed on V8 agar plates and interspersed with a 1 μl drop of different pseudomonad strains between the rows of hyphal plugs. Antagonistic strains were identified by a clearing surrounding the bacteria. FIG. 2 shows the results.

### Example 3—Evaluation of Pseudomonad Strains Against Pythium Isolates

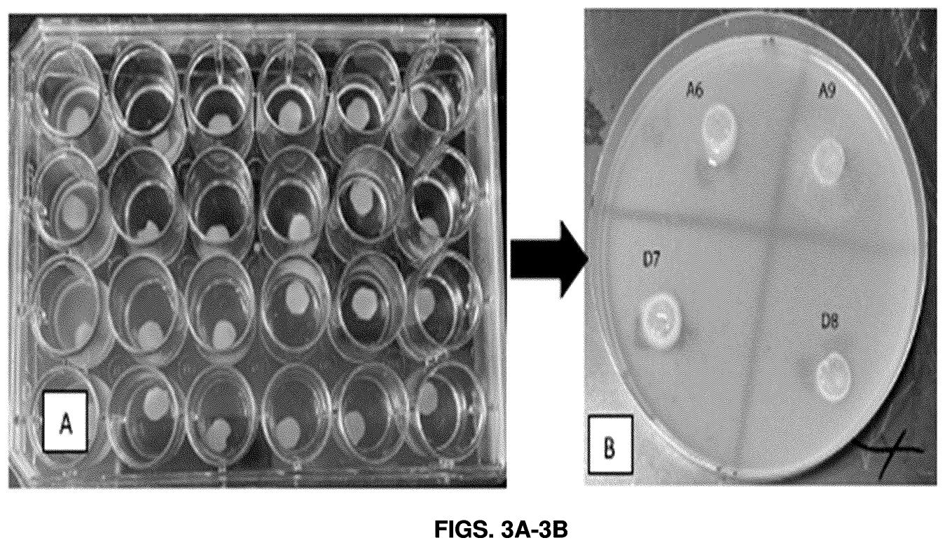

To identify antagonistic interactions between pseudomonads and pythium isolates that resulted in contact-dependent killing, of Pythium strains, 3 mm hyphal plugs were transferred to 1 ml of 1:10 dilution of LE6_D7/A6/D8 suspension and incubated overnight. (FIG. 3A.) The next day the plugs were then transferred onto a fresh plain V8 plate and checked for hyphal growth. FIG. 3B shows the results of four pseudomonad isolates against a strain of P. dissoticum. Pseudomonad strain A9 allowed hyphal regrowth on the plate while strains LE6A6, LE6D8, and LE6D7 did not allow regrowth.

### Example 4—Concentration Dependence of Contact-Dependent Killing

Pseudomonad strains were grown overnight in LB media and diluted to a cell concentration of OD600 ~1.0 in sterile DW. This stock solution was then diluted 10-fold six times to create a dilutions series of isolates having a 10⁶ range of colony forming units. Cell culture plates with 24 wells are used to accommodate four pythium strains exposed to a six-fold concentration for the Biocontrol isolate.

Hyphal plugs of rapidly growing pythium isolates on V8 plates were transferred to cell culture wells and incubated with the biocontrol strain for one day. Then the hyphal plugs were transferred to a fresh V8 plate and tested for regrowth. Absence of hyphal growth indicates that all the hyphae have been killed.

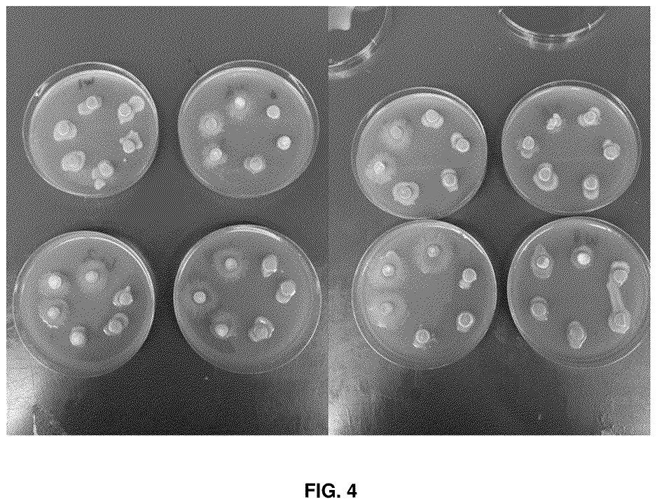

FIG. 4 shows the contact-dependent killing of Pythium isolates by Pseudomonad strain LE6D7.

### Example 5—Biocontrol Strains are Effective Against a Wide Range of Pythium Isolates

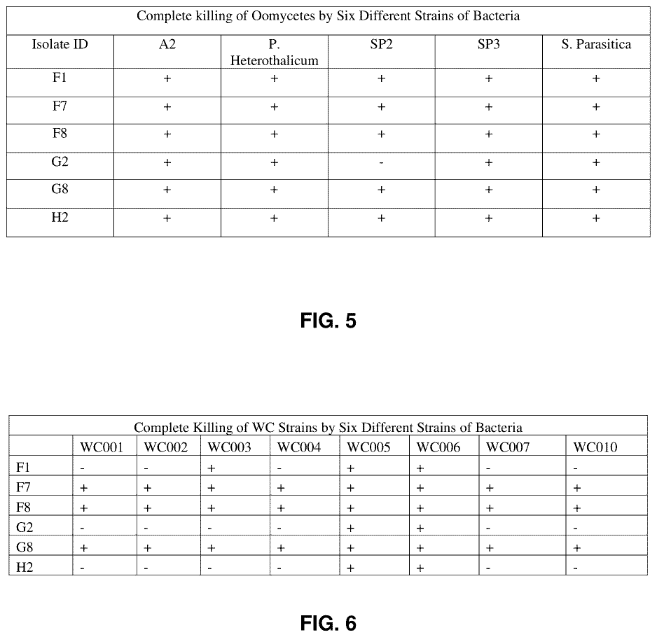

FIG. 5, Table 1, shows contact-dependent killing Pythium strains with exposure to specific pseudomonads.

FIG. 6, Table 2, shows contact-dependent killing of 10 pythium isolates from agricultural fields from Wood County, Ohio. Airborne dust from farmer fields is a possible source of introduction of Pythium pathogens into hydroponic greenhouse operations. This survey indicates that this group of bacteria is effective against a wide range of isolates.

### Example 5—Targeted Knockout of a Predicted Virulence Operon Results in a Loss of Virulence

Upstream and downstream sequences were amplified by species specific primers and then joined by fusion PCR. This sequence was then ligated into the plasmid pDONR1K18 ms using BP Clonase reaction. The resulting plasmid was transferred to the biocontrol strain Pseudomonas fluorescens LEGD7 by electroporation.

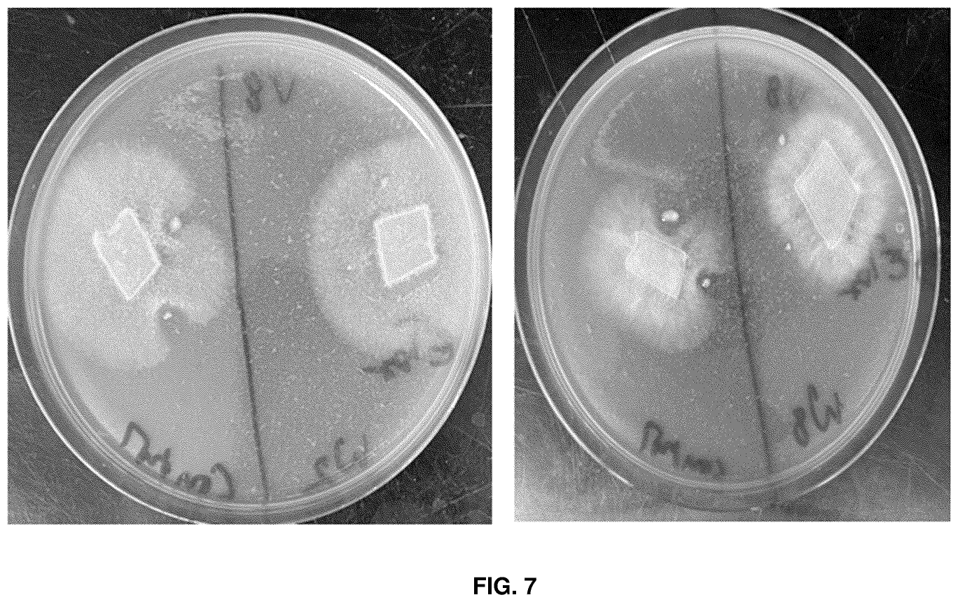

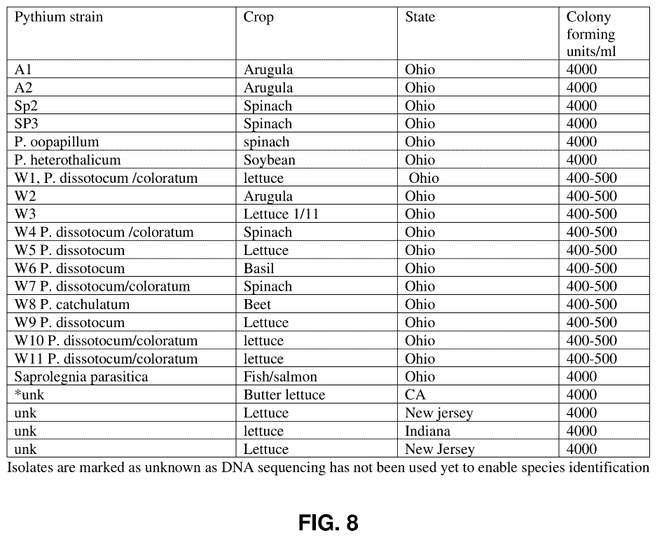

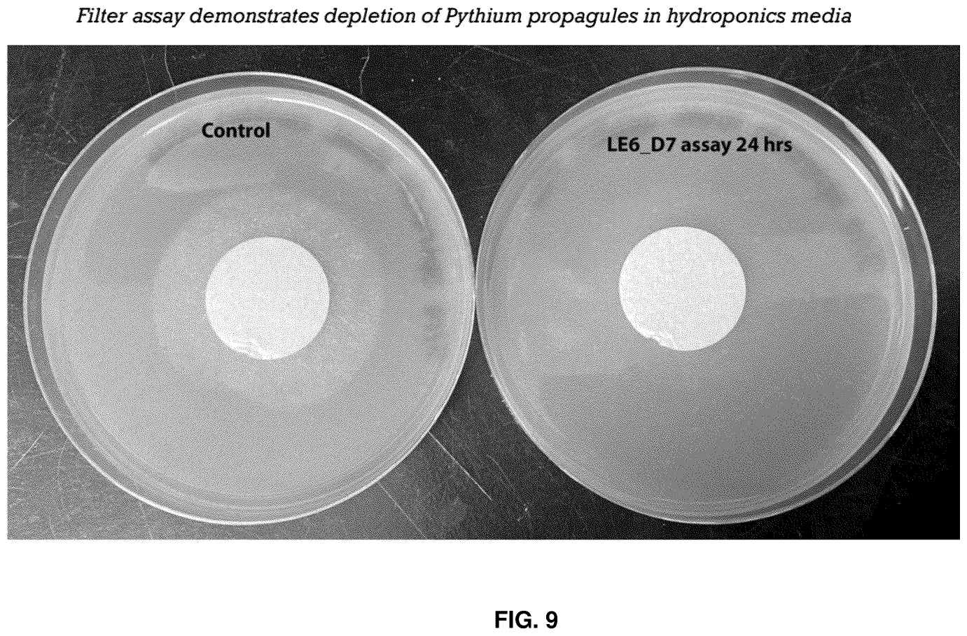

Transformed isolates were selected on kanamycin LB media. To test for an alteration in virulence phenotype, an agar block from a growing pythium culture was placed on a V8 agar plate adjacent to an inoculations site for the WT LE6D7 isolate or the isolate containing the inserted plasmid. FIG. 7 shows the results. The presence of the plasmid in the genome resulted in a loss of virulence as indicated by the ability of the hyphae to grow over and past the inoculation site of the bacteria.

### Example 6—Inhibition of Pythium by LE6D7

Spinach plants were grown hydroponically in 6 L plastic tub and the hydroponic solution was aerated by bubbling with an air stream. To initiate infection the bubbling was stopped and two agar plates with a fresh culture of the Pythium pathogen were added to the water. To maximize infection aeration was stopped for two days. Then, bubbling was restarted and inhibition of plant growth and darkening of roots was clearly evident after 4-5 days.

To test inhibition of Pythium by LE6D7, 50 mo of an overnight culture were added to 5 L of contaminated media (no plants). After two days 10 ml aliquots of the contaminated media were passaged through a 25 mm glass fibre filter and the filter was transferred to V8 media plate with antibiotics to prevent growth of bacteria. The control plate showed rapid regrowth of hyphae indicating a high level of infective propagules in the media. In the treated culture with LE6D7 there was no evidence hyphal growth, indicating complete killing of propagules at this concentration.

### Example 7—T6SS

To test the role of T6SS in pseudomonad-pythium interactions, targeted knockouts to one of the four HCP1 genes in one of the antagonistic strains were generated using a gene deletion strategy, and the vectors were developed for functional analysis of the plant pathogen Pseudomonas syringae DC3000. When the WT strain of LE6D7 was plated on a V8 agar plate adjacent to hyphal plugs of three different Pythium strains, there was no hyphal growth in the direction of the bacterial colony, while hyphae grew rapidly in the opposite direction. However, the Δhcp1 deletion resulted in complete loss of virulence by the bacteria, as that area of the plate was overrun by hyphal growth. This experiment indicates that this protein complex is involved in the delivery of effectors into Pythium cytoplasm. Notably, deletion of this gene did not result in virulence against all strains, indicating that more than one HCP protein is involved in bacterial-oomycete interactions or that additional virulence mechanisms are active.

Dhcp1LE6_D7 resulted in loss of virulence against some Pythium strains. Both Pythium isolates and the biocontrol agents grow well on standard V8 agar. WT strain LE6D7 demonstrated contact dependent inhibition of 3 pythium isolates from commercial GHs. V8 agar plate was inoculated with 3 hyphal plugs of different pythium strains, and the pseudomonad was placed adjacent to the hyphal plug. At 24 h there was no growth of pythium in the direction adjacent to where the microbe was placed. Dhcp1 knockout enables the hyphal strains to grow over the microbial colony, indicating a loss of virulence of the mutant strains against this host.

### Example 8—Killing of Pythium Isolates

The strain LE6D7 exhibits complete killing against a collection of 35 pythium isolates that also include 6 isolates from geographically dispersed GH operations located in Wisconsin, Indiana, Michigan, Ohio, Ontario, Canada, and New Jersey.

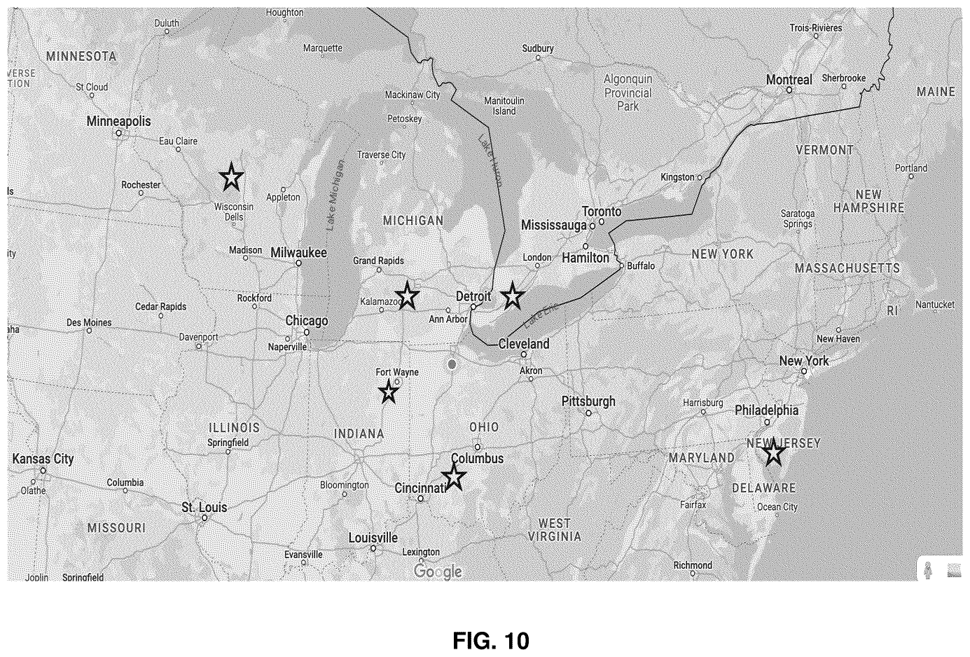

LE6D7 is an effective contact-dependent biocontrol agent of all isolates isolated from infected roots of leafy greens in the collection tested. Six isolates are shown for illustrative purposes to indicate that this isolate exhibits broad killing activity on pythium isolates obtained from commercial operations across the Eastern US and Ontario, Canada (FIG. 10).

To evaluate the minimum concentration of pseudomonads needed to achieve complete killing of hyphae, pseudomonad strains were grown overnight in LB media, adjusted to an OD600 ~ 1.0 and then diluted up to 10⁻⁶ in sterile water (approx. 2-4K cell/ml). One ml aliquots were added to cell culture plates containing hyphal plugs from freshly growing plates of different pythium isolates, and incubated for 24 h. After 24 h, plugs were transferred to a fresh V8 plates. Hyphal regrowth was assessed after 16-24 h.

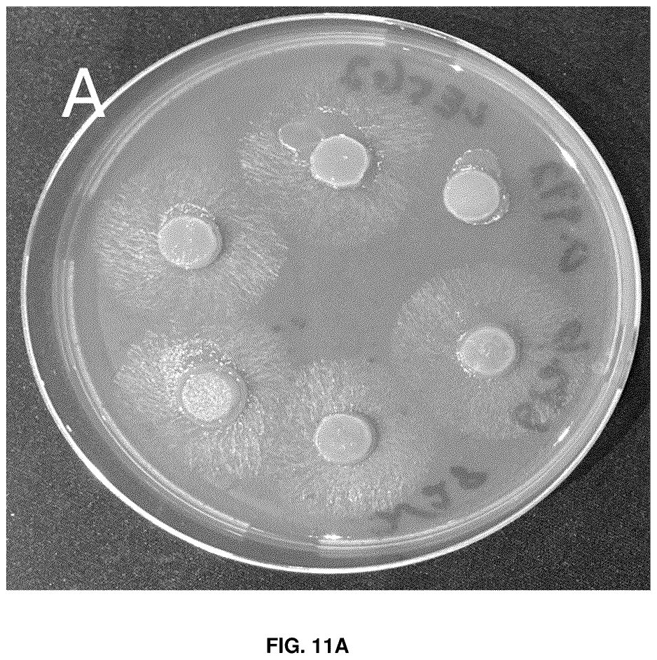

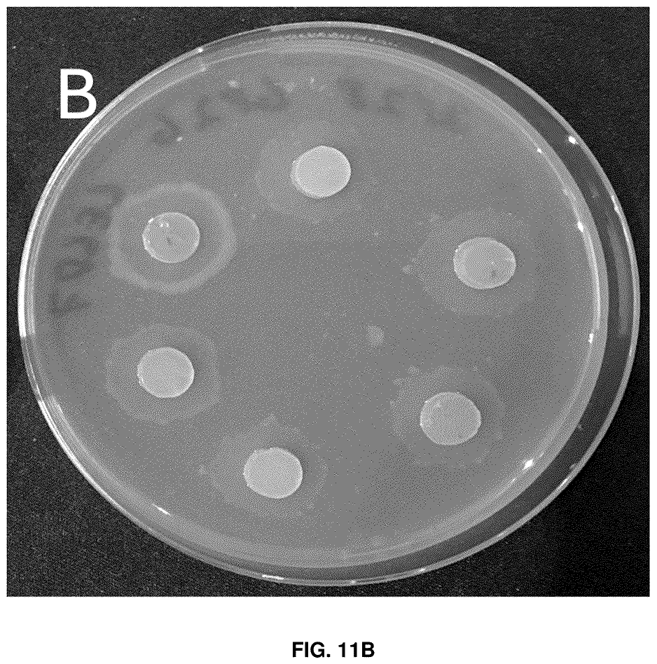

The isolate LE6D7 was an effective killer of all the 32 isolates tested to date, while the isolate LE5G2 was less effective. In the latter case, hyphae exposed to lower concentrations of this isolate exhibited regrowth from the hyphal plug (FIGS. 11A-11B).

### Example 9—Killing Saprolegnia

The strain LE6D7 is an effective biocontrol agent of seven species of the fish pathogen Saprolegnia. The contact-dependent assay described above was also used to determine if LE6D7 was also capable of killing Saprolegnia isolates. These assays also show that this strain was an aggressive killer of 35 environmental isolates of Saprolegnia that included six different species. Table 1 below lists isolates of Saprolegnia killed by LE6D7.

TABLE 1
List of field isolates of Saprolegnia collected from
Ohio and Michigan, confirmed as Saprolegnia species
by ITS sequencing, and killed on contact with LE6D7

| Sample Number | Field Isolate | Saprolegnia |
|---|---|---|
| S13 | ML2_2 | S australis |
| S14 | GYB21 | S. australis |
| S16 | GYB1_1 | S. ferax |
| S17 | GYMR1_1 | S. delictica |
| S18 | GYMR2 | S. longicaulis |
| S19 | B5_1 | S. salmonis |
| S20 | MR3_2 | S australis |
| S21 | GMW01-GY-01 | S. ferax |
| S36 | MR2_1 | S. parasitica |
| S38 | B2-3 | S. parasitica |
| S39 | TB1_1 | S. australis |

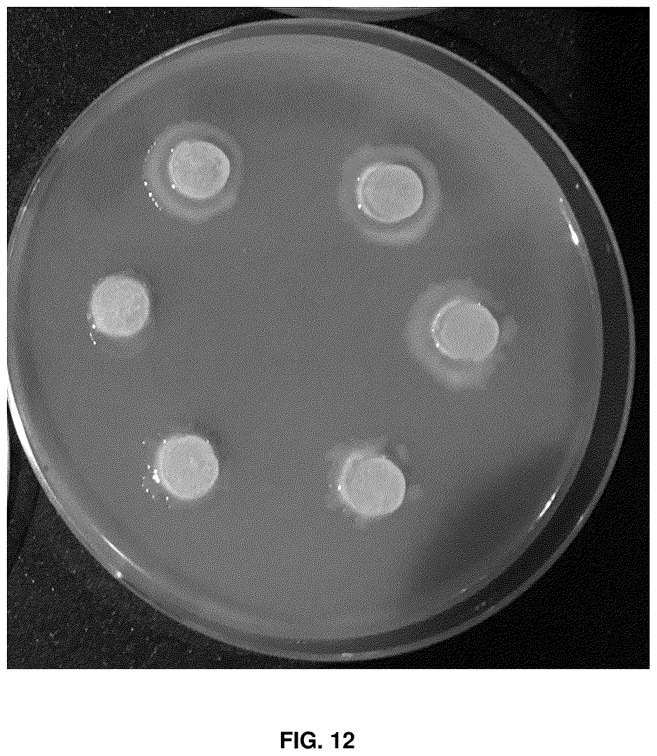

FIG. 12 shows contact-dependent killing of an an environmental strain of Saprolegnia by LE6D7. The V8 agar plate contains six agar plugs of tan environmental Saprolegnia isolate arrayed on a V8 plate. These hyphal plugs were previously incubated in six X 10-fold dilutions of LE6D7 bacteria in sterile water (1 ml) for 24 h before being transferred to a fresh plate and arrayed in a clockwise fashion from highest to lowest dilution. The absence of hyphal regrowth from the plug indicates all the hyphae have been killed.

### Example 10—Genomic Analysis

The isolate LE6D7 contains two complete T6SSs and a large number of associated effectors to target oomycetes.

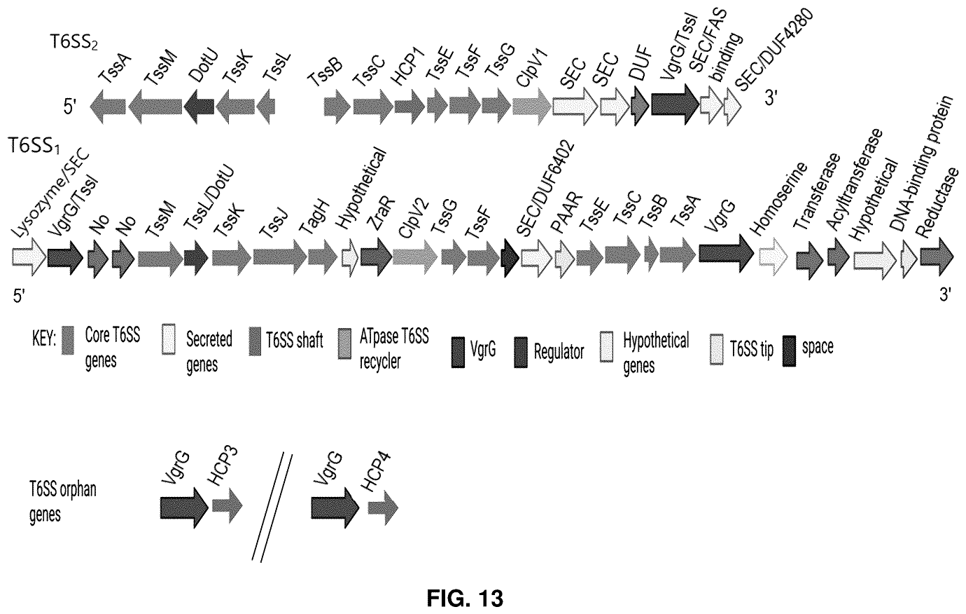

To facilitate bioinformatic analysis, LE6D7 was sequenced by a combination of Illumina and Nanopore reads at MIGs, Pittsburgh, PA. Genome assembly produced a circular genome of length 6,333,768 bps and 5622 genes. Comparative genomic analysis in NCBI databases indicates that LE6D7 is a Pseudomonas fluorescens strain. LE6D7 has two T6SSs with 12 VgrG1 genes, 4 hcp genes, 4 PAAR genes, and 1 clpV gene (FIG. 13). Associated within T6SS1 and T6SS2 or clustered with vgrG genes are an additional seven genes that are predicted to be secreted by the T6SS (Table 3) and six genes with conserved motifs indicating they play a role in the assembly of effectors into the T6SS (Table 5).

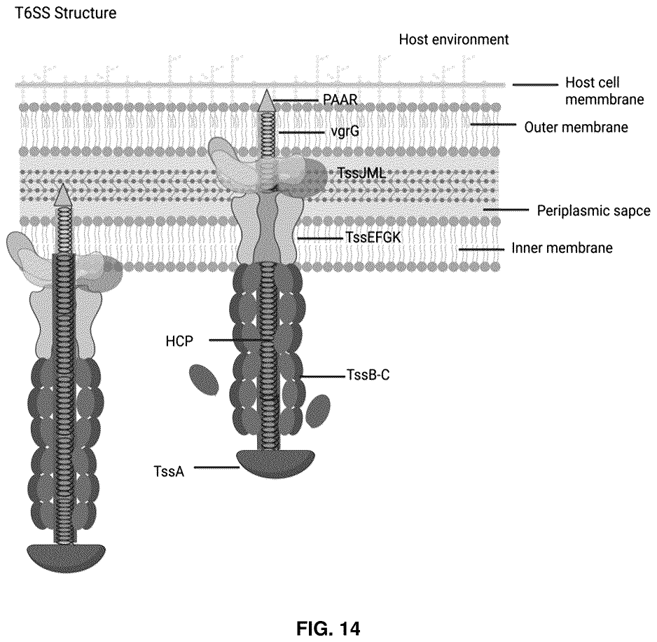

T6SSs assemble into a kind of nano-crossbow or rocket-like structure which spans the two bacterial membranes (FIG. 14). The HCP protein monomers form a hollow shaft, that may contain additional effector proteins, and the vgrg and PAAR proteins form an arrow tip. These proteins are delivered by force into the host cytosol where they disassemble and release additional effectors contain within the shaft protein or noncovalently attached to vgrg proteins. Protein domains within the vgrG or PAAR proteins may interact with specific proteins within the cytosol to mediate cell death. Interacting proteins with T6SS often have a predicted secretion (Table 4) of small peptides without secretion signal that are contained within the Virulence islands of T6SS₁ and TSS2 or associated with one of the 12vgrg genes may also be pathogenic factors (Table 5).

TABLE 3
Secreted proteins associated with T6SS

| Sequence | |
|---|---|
| Identifier | Sequence |
| SEQ ID | MTETTNKIQKWSYPLKVGTAEATDPQQFYKALAKAKDGYYPLGANGLWHGGVHF |
| NO: 1 | DEASGLVKDLTEVRCIADGEVVAYRIDEKYPTSDFGSTHSVYSTGFVLVKHRLELP |
| | APPAPAAGAAPASSPVAGPSLTFFSLYMHLLDWEGYKANPTLKDRPGFWGKGLYE |
| | VKANAPDKPLGIRMRSGNAGHFPVLAVLPRGTTVVTQPAPANQMWVAVISVSPEIA |
| | GLPAGGWVYKGQLKDLGGGKYFVGNEAQDPVPGGAQHGANIRGAHTSGLPLSHL |
| | SAGAQVRLGDEATPNNFRKLAEIVSGQATPALAPGADGKLPGFIWLQSLTPKSEPHS |
| | PMGDVVVLSPTYKIKAGEILGHVGKYQNHSDAAPKNLLHLEVFSCEDVKAFTEQSK |
| | AKAAGAPVAEKSIVKIPVGTKLITHVQGMNATNPPKASDAGNDVGYDFYVPVGLL |
| | ETLPADKKIKQTVTMGQSTTTTYWWRLDGLLGDKDGNGIDGWFAEQDIVISRHSPF |
| | EWNGFDFIEETTSNADHFAAFLHAQENLSEQEREGYLPNVEAAIAGSVNEKLYKILD |
| | RDGDKKIAPTEIAEALNKPWFSQPISQMVTRYENEWDFKKDKWDALDEIIGHSDSE |
| | PHEEWVEEKARIEKLSWWSKLLGQHGITSNASVQHIHPIGLISSFAHAGGCSCSDTIT |
| | KDQMKLIDPSATQANIDKYTDLLG0EMFERSGVAKCISKAHILAQMLHESGHLHYT |
| | VEGLDPDKPLPTYHPYIGRGLMQITHRVNYEAYGQFAGESFIGAPNYNKLGQLPHS |
| | VLSAGWYWVDYKKILTHSDADDFIYCTILVNGGLNHYDERLLFLNNALKALDIKG |
| | CAKLNKSGAYDLLDSKAYNKAKFSFAWGLWSDPAGGKAGKTPDAAQAIIGYKRF |
| | LDLYNSDSSVSGNTNTTYYASGRIASVAKQYAEARIVALGGTL |
| SEQ ID | MEVFMGTIQPFAFNFAPSGWALCNGQILGISQYQALFALLGTYYGGNGTTNFQLPN |
| NO: 2 | LQGRVPVAQGTGLGLTPRVIGQVYGTENVTATIANMPNHTHAMTGLTANTALSLA |
| | VPASNPATVPTATNSYIGASGGGPGSANIYSDAQGATPVPLKGVTTTVTGDISSTGG |
| | SQPLPILNPALVLNFSIALNGLFPSRN |
| SEQ ID | MAKNKPLTTAQKPLTPKADTASAKVAVDDSRRLKEIRKLVEANNQSKIDTNTVICQ |
| NO: 3 | IYMESHFDPEAGRGKHSARGLMQMQEPAVKQVYKYRKKKELGRMPNQAQTDEAF |
| | SAGAAFYASPSIWDEAENIK |
| SEQ ID | MPLPSAPQQRPVINVLSPHNPNHLCILSVVLGVIGQHVTTKSPEEVQAYTHPGESTIY |
| NO: 4 | VAANKNGESLIAACEVLLTAIHPGGSNALMEAARILHVLFSETDRVINQNIPEYELQ |
| | ESWLKSNQVGNKNGNWATDENSKLVRWKFLDRAPIIPDTKLYVTNMPSKTAEEKA |
| | KVAEKILELTYNPRLNTKQLNNLLNLVKAFKEQKPLPRTVVLSPITKITNTPPTPHAL |
| | QYVENDGYHAEISLMRALIIGSGFKPVIKGNLGGKKAACAKCSAWFSKVKTLSANQ |
| | IDPSFPNEAEFGNLRPQRQSPTNWAAPKFSPHVFSSTDFTVFKTVYEGAGKVTTSAE |
| | EELMEFT |
| SEQ ID | MPLNPEYKSTTVNVNGSNVTVPLYAKATLTSTNMTGGSGPDQSLRPPGFVSGTCPE |
| NO: 5 | HHQRGHLIGNKLGGSGTDLRNLVTLTEGSNHPIMYEYEAMVYEYVKKNPGIEFVY |
| | QVTAQYDTSRYLVAQVAPGGSTSGAANNPYCPLPCPESLRIDFFYAEAPGKLNYPLI |
| | YRVLTEHGEGWNTGPLYILNGVYKFHEGSPKHVAQGCWAS |
| SEQ ID | MAITPLDLQQDDKQLKGRLQDGQLDGPLNIKDDGRKQADLNYSQGELQGTSLLYH |
| NO: 6 | PNGKVSAQMPFVRDKLQGIASFYAPEGWLQRKASYRRGLLHGEAFNYFPDGQVAE |
| | AEFYRDGVREGRYQRFHPNGKPAVDARYLNGQLMEPEQGFAEDGRPLDADGKPIS |
| | RVRWWFRKWTDPQQA |
| SEQ ID | MGCPQVCASATLQCSFGAAPAVLNVLPVNRTLTGGMPAANIMDHIPLVNVTTFGM |
| NO: 7 | CMSMANPMVAAATAAALGVLTPMPCIPATATPWIPGGAPTLLLGGMPAIDANSTL |
| | MCNWAGVIKIVMPGQMQMLIP |

TABLE 4
Predicted chaperones

| Sequence | |
|---|---|
| Identifier | Sequence |
| SEQ ID | MRRSAKNASAARVVSVQPEQWLKDVPLKPSEQLFAIFSSASAAEPLKAWPLKAQ |
| NO: 8 | MPKPVWAETIYAEWDAVMPYVGIVDAGSEFLDWVATTESRDWGWLAVSSAGL |
| | EAVVEHFRSLTQVLMPDGKVVFFRFWDGRYLLPILESSEVDAGQLLPVLTRGFIN |
| | GQAVEIGGRAGVSGREFPWWSVPEKLLTQFGEDARINNALQWLSEEQPALFEAF |
| | PADVLRCKVVRFFAVSASDESSASALLEYLRDESE |
| SEQ ID | MSVSTPGQRAQWLLLDIAQAPQAVQTLRQGFAGVHSLKLFDGTEFQPVSDQGP |
| NO: 9 | WLIDLRDSPALSALCHADPLTWQGLLLGSEASASLLREHLQRMLTVSVGLNHRA |
| | LLNFYNRQTASYFFDACNARQLSCWLGPIAWLRWFGGTWADLAGGSQGWQQL |
| | RNPGLAVEPLRIEQSLTRQQRERLHRCLLDQHVWRWSQATGNDYRLMSSFQEQ |
| | GLELGFSEQALLDDWLWLRLQHPRAELTPLPQGLPPRERLELLRRRWLNDPS |
| SEQ ID | MLNPEWPLENGLPEGLPWNGTVGLLLDGVSVEKLPQHLYQWTDNPEFEPLYLG |
| NO: 10 | TRWAKLGDISPCLVRIKAQNDPILAKFLNASRQEWGHLVFSDQPWDQLVAHFR |
| | WLTSVMHPQGEEVLLRVADPAVTHALLSHAETIKDPTLFGPCTQVVTADAALGC |
| | WHINRRQGITSEPNHSKRYRLSDEQLSQLDEVNFRNVVMRLDEHMHEYFPSYQA |
| | QSTPPQRWEHLHALASTSYDRGFNTELDITLYANIHGFLGERALEEHPDLDAILKT |
| | PSEQTPAQRLERVADMAQERAAG |
| SEQ ID | MSKTVIPPLEDPVSPYEFPDSRKLHDAAERALDYYLTPAARIMATPYTPNDMFM |
| NO: 11 | VNPQTDTESLLANACESLASATVMLGDFAGLLEGPNRKTLLGIAQVVMLGELAV |
| | NQALDNLVPKE |
| SEQ ID | MSGYIPNPPKNYRNKGTDPVDIHAQRRAEYEKHGKEPASAREKIGIALRIGVFFD |
| NO: 12 | GTGNNANNAAAGLLCGAHHPIAAQDIDASCKPFMKDPDSSYGNDTSNVQKLSD |
| | LYYAPQKAEGDGSQKQAFRMVYVEGIGTRSGMEDSTLGAGTGRGETGVAGRV |
| | QLSFSEIKLRIEGVLASHPESEITSLTFDTFGFSRGAAAARHFANEIARGKQGPLGD |
| | VMRSSARGFSSTFNDQYKSSINMGFIGLFDTVPSIAGWSNLGNIKSPVATGIRLYL |
| | DRRYFSDVVQLTARDECRANFALSRVKPDHLEIVLPGVHSDLGGGYLEEAQENV |
| | LVSPMQSLDVSQNTDVVTTSIYRDAEIVKDQLLAKGWPAEMLEIVTPAALPLPNA |
| | LQDRLSPRLKRVYAAVQLKRPVSGMLSRVYLRLMHQLAKEKGVRFKDIPDTPEL |
| | AVPSELQALCDRFLAGDYSVTPQEEKLLKLKYIHTSANWNHPLGRRDGSGMSAV |
| | YINAPTADSIRVQHPHVPDWTLW |
| SEQ ID | MSFDIFPTLEHEIRLSPPERAVTLIAACNTNEIGRFNVRETVYQTLIGSRPEQRKTQ |
| NO: 13 | SWIFTSSVIRAQTDSRDRVMVFVSVKKKYLKKVSDSLNGWSCPHGTPMQVIKVQ |
| | HGIASSQLVFANS |

TABLE 5
Proteins clustered with T6SSs

| Sequence | |
|---|---|
| Identifier | Sequence |
| SEQ ID NO: | MQFKNLAVPLLGLMWTLQAFAETSTFSPTQGVEAALVLEGSTLNIAVKGETHNE |
| 14 | SRTIDFQAENELHVQVDDFNFDGVKDFAIWQLDDGMGTYDYYRVFIYQVKTGT |
| | FEELQPDCGDGFVNLRVDKKRKALLSTYWEMNIAKQCVTRFAKRKA |
| SEQ ID NO: | MIKVAVFFILTFMATAASASSGCEADLNGDGICDPYSVSPLEDDGTISRITIDIGGS |
| 15 | NKSVSGNFELGDGGLSVGYLPSEFSLLLDFYTRNTDLTQFSFKWSSAQQDWVLY |
| | KKSTWVEPSRDEKYTLSGEKAPIELLFPQQFNVQRIACCTLFSQFSESAPNFSYLS |
| | DETQLAEIRKDFKYILSKLPQGEKGELFYGLDDSGNKVRRNIPQELVYELTLIVA |
| | DDNVGPLNDYAYYLYRSKNNVLAALLLREIHKKFPERVVATLNLADAYWDIGM |
| | RSDACPLYKEYIAQMTKNGKGGRIPQAAKSRENCN |
| SEQ ID NO: | MSNYYRIAMCLFVHAFGCVAYVFLNNAVVHAYKHLNGGFTTRGVAIGIASYAM |
| 16 | FYIFLGVNFIAALIPSLVAKLVILSLMVGFILLWMLPDNPLRALFYGVAQGCVTLL |
| | AILASQVIELRWVLRNIAGRIQPNQPESAIQ |
| SEQ ID NO: | MSARLFLTIGFALLAGCSFFGPKVDLDSLTLDVAPKANDDTPIAVDFIAVNDPDL |
| 17 | LKQLSGISARQWFAEREQYQRDYRQLMSVWGLELVPGQFIDRQPFPLGGKRAA |
| | GLLVFASYNTPGAHRLRLDDQSDAWLKFDSREMSLVSKEN |

Table 6 provides the sequences of Hcp, PAAR, and VgrG proteins in the Pseudomonas strain LE6D7

TABLE 6
Hcp, PAAR, and VgrG proteins in Pseudomonas fluorescens LE6D7

| Sequence | |
|---|---|
| Identifier | Sequence |
| SEQ ID NO: | MATPAYMSVTGEKQGLITAGAFTADSVGNTYQEGHEDQVMVQAFSHDVIIPRDP |
| 18 | QSGQPTGQRVHKPVIITKVYDKASPLLQAALTSGERMSEIVIQWYRTSAQGTQEH |
| | YYTTKLEDAIIVAINNKMHNCQDPSNAHFTHLEEVQFTYRKITWTHEVSGTSGSD |
| | DWRAPVV |
| SEQ ID NO: | MATPAYMSVTGEKQGLITAGAFTADSVGNTYQEGHEDQVMVQAFSHDVIIPRDP |
| 19 | QSGQPTGQRVHKPVIITKVYDKASPLLQAALTSGERMSEIVIQWYRTSAQGTQEH |
| | YYTTKLEDAIIVAINNKMHNCQDPSNAHFTHLEEVQFTYRKITWTHEVSGTSGSD |
| | DWRAPVV |
| SEQ ID NO: | MDAIILDLGGDIKGDSLLEGYADKIEVMSYSHNVAMQVTNDVSNSERTSGKPHV |
| 20 | GEFTLTKFVDTSTPSLNEYCCAGKPIPEAKITIGRNAAEGSGQLLPFIIYTLTNVVIS |
| | NVSVSGGTGGKPVETLSLNFTKIKWELTAQKDDGTKEGTAASTWDMAANKLVS |
| SEQ ID NO: | MANPAYMTITGKTQGLISAGCSTPESVGNKYQKAHTDEIMVFALSHEMRRDNNL |
| 21 | GKAVHQPVIITKAVDKSSPLLAQAHSNSEELECTISLYRTSPQGQQEKFYSISLDGA |
| | VLAELSQEVPHVILQNDAQPQEQLAIRYRGISWVHHIAGTTGHTSWGSQD |
| SEQ ID NO: | MSGKPAARVSDPTACPLPGHGTNPIAAGSGDVFFDGLPAAREGDASACGGAMVG |
| 22 | DLATTVLINGKPAATVGSVGSHGNKVTAGSGTVIIGNSHSPAPFVPPLPVEIQWPF |
| | SQHFVVRNPRTGAPVADRPYTLRTASGKEVRGVTDAQGRTRPIASHLAESVTLIV |
| | EEQTSLVIA |
| SEQ ID NO: | MAKPAARKTDPSSCPLPGHGTNPIATGSPDVFFDGLPAARQGDTCTCGSALSSGLS |
| 23 | STVFINGKNAATIDTGGTHGSIVIGGSGTVIIGDTHTPCDFVPPTLLAGHARWIGFRI |
| | PADESYEGLSCTAHFEDGSTLPGVF |
| SEQ ID NO: | MAKPAARLSDLNACPITGHGTNPSTSGSPNVNINGMPVLRVGDTTACGDSVTEGI |
| 24 | GNILINGKPIAFLGSATAHGGMIITGSGDVFVGTQVGSAPFSPIVTVPKHSERFQLV |
| | DETTGEAIPDMLYCIETGDGQRLVGHTDNHGNAARVFTADPTSIVVQWGKEAAA |
| | HLDALGIDY |
| SEQ ID NO: | MSGKPAARVTDPTACPLPGHGNNPIVSGSPDVFFDGLPAARMTDKSACGSPITGG |
| 25 | VSATVFINGLNAAMLDSTGGHGNVVVGGSGTVIIGQSGGGAAFSGLLPMPV |
| SEQ ID NO: | MFNPANETHFSLTVEDYVGDLQVLSFTGIEGISQPFRFDLELVSENPDLDLEKLLH |
| 26 | KQAFLALDPQGSGIHGQIYRVAQGDAGKRLTRYKVSLVPQLQYLHHRTNQRIYQ |
| | QMSAPKIIALILDEHGIKGNAYSFQLSQTCPDRDYCVQYDETDLHFVQRLCEEEGI |
| | HYHFQHSQKGHLLVFGDDQTVFPNLGQPTAYVQGSGMVAEEPVIKGFKLRLETR |
| | TSRTTRRDYDFEKPRLQMEAAYKPDGALDSKDAEPDLEDYDYPGRFIDRARGKF |
| | LSQRALERHRADYRQAEGRGDQTRLVSGHFMEMSDHPRSEWNDLWLLTEIFHEG |
| | KQPQVLEESVTSDTTDNKDDFHQGYRNTFLATPWDVFYRPALEHPKPRVLGSQT |
| | AMVTGPKGEEIHCDQYGRIKVQFHWDREGQADDKTSCWLRVSSSWAGDRYGAI |
| | SIPRIGMEVLVTFLEGDPDQPLVTGCLYHKENPVPYALPANKTRSVFKTLSSPGGG |
| | GYNELRIEDKKGAEQIFIHAQRDWDENVEHDQKIRVGNERHDTVVKNTYTELKA |
| | EEHRTTISDRKIEARMDDHLTIGESQHVKLGTAQLTSVGKEIHIKAGDKIVIEAGTE |
| | LTILGGGSFIKLDGGGVTVVGPVVKINAGGSAGSGTGIGIKPPVLPGAADKDKAGS |
| | LMDQALLNAPEEQAKRKPKRMLNFSG |
| SEQ ID NO: | MSGAVSSARFTLQIPAVRNDFKVLAFEGTETISTLYAIHVELVSEDPDFDMEGLLG |
| 27 | QPAFLQFGLNGEGIHGRIDDVLAGESGKRLTHYRLILVPSLHYLQFSHDQRIYQGQ |
| | TVPQIITQTLKRHGILADAFTFHVQPLAARDYCTQYDESDFEFIQRVCAEDGIAWH |
| | HQHSAQGHLLVFTDDSVFLPTLRATPYRRDSGMVPEYPVVSRFSLRAATRTSRVT |
| | RRDYDLRRPTLLIESRFSAEFTPTLEDYQYPLPLANEKRGKQLARQALERHRADY |
| | EMAEGQSNQPTLRCGHLLELTEHPRQKCNDLWLLLGISHTGRQPQVLEESVSSET |
| | QSADGFTQGYRNTFHAIPAEVVFRPPLPARRPPLVSQTARVTGPKGEEIYCDEFGR |
| | VKVEFHWDRTELNSERSSCWVRVSSSWAGNGFGVVTLPRIGTEVVVTFVEGDPD |
| | KPLITGCVINKVTPAPYKLPEHKTRTVLRSRSSPDTGGYSEFTIEDRAGLELVYLRA |
| | QRDMERQVLHDSRLAVGRDRWESIQGSSQTTAGKIITVEAGQQVQIKAGASVVL |
| | DAGASITLKAGGHHIVIDSGGIFSSTEMVAGGKTSASGAADHPEAAMAGTLAAGP |
| | ATASTQAAEEGELEEEEEEVELEDELPAGITLRIGVFFDGTGNNLFNSEQVKGCYA |
| | RDVNLEEEAEDIRQFCQMHGYDGQGNVPDNSYGNDASNVARLYELYRDDQGRQ |
| | LAKEETIAYIPVYLEGIGTSADKDDSVFSQMTGTGAQGVLARVKQSPTSIIPGIRLF |
| | ESANPTLKVESVQFDIFGFSRGAAAARHFANEVMKGEQSPLAQLLPADSSLFLESF |
| | SWRANIDVSINFIGIFDTAAAIGSMADGDFSVHDANNPGVNLYLAPDIAKKVVHL |
| | VARDERRHNFSLNSAGNADIVLPGVHSDLGGGYLPNLVERVLLSKPRCSRDVDEN |
| | TPSSSTNAYRLAEQELGRLQDQLHFYGLTLQVKTWAVETASNVKGDRRKSKNVY |
| | AAVYSERVVRNDLSLIYLRIMRELANRHGVEFETINQESQSYALPGELKGIARKL |
| | MMFALGESRSLDLSLNEHALLAQRYIHLSSNWNAAKGLNETGLSILFINRPADQS |
| | VRVVHPNA |
| SEQ ID NO: | MFNANARLRLITDAFKHDLQVLSFTGTESISQPYSFDVKLVSPRPDIDLPGLMHRQA |
| 28 | FLAFDDHGHGVHGQIQHIGKDDIGYRLTQYHLTLAPCLTNLGHHFNQRVFQHLSVA |
| | QIIGQILQEHGIHADGYLFQIGQALPDREYCVQYNESDLHFIQRLCQEDGLHYHFRH |
| | SLDRHLLVFGDDQTVFPRLARPTPFKPRNAMVADRPVIHRLDCGLNTRTSRASRRA |
| | YDFERARIVLESDARIPNENCQPDLEDYVYPGRVLDREHGKLLARRILERHRSDERV |
| | AQGDSDEPALVSGHFLSLSEHPDPALNDLWLLTEIEHEGQQPQVLEESGSDIAVSDK |
| | SDFVQGYRNHFEATPWDVIYRPPLRYDKPSIGCTQTAVVTGPEGEDIHCDSYGRVK |
| | VQFFWDRKGRHDDKSSCWLRTTTNWAGNAHGSVIIPRVGMEVLVTFLNGDPDHP |
| | VISGCLANSANPVPYELPAHKTRSVFRSRSTPDSNGFNELMIEDRAGQELIYLRAQR |
| | DLQQKIEHDSHLDIGNQRRETIKGNSVSVLHAEEQRTITGDRKTHLKASDYLHVSQ |
| | NSHTRIGQSLTVEAAGQVCLSAGEHLVLEAGKSISLKVGGEHFVLDHGGLFGSSDL |
| | LIGGAPAAFLRAPILLPDSVEDLAPSTPLPPLVAPSQTALMADSKTLGADFCPICEAC |
| | RGGACLIEGAAA |
| SEQ ID NO: | MFAPANQPRFTLTVEGALFDLKVLEFTGKEAISQPFRFDLELVSERPDLDLESLLHC |
| 29 | QAFLSFDEDGSGIHGQIYRVGQGDSGKRLTRYHVSLVPRLAYLGHRINQRIFQHQSV |
| | PQIVTQILKDHAILRDAFEFRLGSDYPPREYCVQYAESDLAFIQRLCAEVGIHFHFQH |
| | SPDGHLLVFGDDQTVFPRLAEPTLYLPGSGMAASAPAIKRFTVRVETRTSVVTRRD |
| | YDFTKPRLALQSWVESDQRPVLEDYHFPGQFTDRASGKQLAQRTLERHVADYRQA |
| | EGRSDQSALVSGHFLQLAEHPRQDLNDLWLLTAIEHHGRQPQVLEESVTSEGDEFQ |
| | GYRNTFLATPWDVFFRPPMGPEKPRMLGYQPAVVTGPQDSEIHCDEYGRVKVQLA |
| | WDRDGELNEHSSCWLRVASGWAHDRYGSVLIPRVGMEVLVGFIDSDADKPLVMA |
| | CLPNAATPVPLDLPADKTRSIFRSQSSPGGGGYNELRIEDRKGAEEIYLRAQRNWTQ |
| | HVLNDQQVQVDNQRSVVVTGLAKHELKADEQRITHGQRQTEVKQDDHLTVTGDR |
| | HIRVSNQAINASAQFHVSAGQQVVIDGGASATIQAGGQWINIGPGGIFSSVPIVVGG |
| | APMAAMSAAPTVPGLPEKLVAAPAVILTAAQIMSLKGDAPFCEE |
| SEQ ID NO: | MFDPADEPSFRLDVAGLSDSLEVLAFTGCEAISEPFAFEIDLLVDDPHLDLAGLMYR |
| 30 | SARLCFGPCGNGVHGQLHSLVQHEQGRDARLCRARLGPRLSCLGLRYSQRIFSDRS |
| | VPQILDQVLREHGISGTRRRFDLQGAYPPRTFCTQYGESDLQLVQRLCGQARIHYHF |
| | EHGNRGHCLVFGDDPARLPHAANLRFDCGDGEPSPTVRRWQLGEHAGLYAEGSRR |
| | TRTARGHSDSPTLRSGHWLTITGQPLAEANGHWLVSRIEHRADQLLEPPYSNRIFAA |
| | DRLPVFRSPIEHLGARMRSPQRAWVVSVEEAQPDAVRPVAVQFDWLYQGEGARPS |
| | HCWLPLAPALADTPMASLQDGAEVVVSFLEGNPEQPVISGVLQIPALTKAIEDDASP |
| | PLPERLASAGLPQWLKAAEPLLLLCLIPGGGSYRHCAASLCSCRLVGGLKTSDAR |
| SEQ ID NO: | MFAPANETHFALTIEGLSADFQVFTLTGREAISQPFVFEVELVSEQPSLDLETLLHKP |
| 31 | AFLQLSPDGSGIHGLIYRAAQGDSGKRLTRYSVTLRPQLAYLAHRINQRIFQNLSVP |
| | KIIGKVLEEHGIQGNAYAFQTGSIYPDRLYCVQYDESDLHFIQRLCEEEGIHYHFQHS |
| | ATGHKLVFGDDQTVFKKLAPVAYQQDSGMVASNPVIKRFDLRLETRTSRTTRRDY |
| | DFEKPRITLESENRGDALPDLEDYDYPGRFVDRERGKHLAKRALERHRSDFQLAEG |
| | KSDQPLLVSGHFLALKEHPKAKWNDLWLLTEVHHEGKQPQVLEESVTSDTTALKD |
| | DFHQGYRNRFQATPWDVPNRPPLRHPKPRILGSQSAVVTGPKGEEIHCDEYGRVKV |
| | QFHWDREGQADDKTSCWLRVSSAWAGAQYGGIAIPRIGMEVLVTFLEGDPDQPLIS |
| | GCLYHKENTVPYALPANKTRTTFKTLSSMGGGGFNELRIEDKKGQEQIFLHAQRD |
| | WDENIEHDQKIRVGNERHDVVEKNSYTEFKAEEHHTVYEDRKVEARANDHLTVG |
| | VNQHIKIGTGQFIDAGQEIHLSSGMKVVLEAGAELTLVGGGSFIKIDGGGVTMSGPA |
| | ININSGGGPGSGTGAAPLMPGVLKQADADKAGKLLVPAQRQALMQKKPICAVCEK |
| | AKLEAQNA |
| SEQ ID NO: | MFAPANETHFALTIEGLSADFQVFTLTGREAVSQPFVFEVELVSEQPSLDLETLLHK |
| 32 | PAFLQLSPDGSGIHGLIYRAAQGDSGKRLTRYSVTLRPQLAYLAHRINQRIFQNLSV |
| | PKIIGKVLEEHGIQGNAYEFQTGSIYPDRIYCVQYDESDLHFIQRLCEEEGIHYHFQH |
| | TATAHKLVFGDDQTVFKKLAPVAYQQDSGMVASDPVIKRFDLRLETRTSRTTRRD |
| | YDFEKPRLTLESENRGDALPDLEDYDYPGRFIDRERGKHLAKRALERHRSDFQLAE |
| | GKSDQPLLVSGHFLALKEHPKAKWNDLWLLTEVHHEGKQPQVLEESVTSDTTALK |
| | DDFHQGYRNRFQATPWDVPNRPPLRHPKPRILGSQSAVVTGPKGEEIQCDEYGRVK |
| | VQFHWDRDGLADDKTSCWLRVSSAWAGAQYGGIAIPRIGMEVLVTFLEGDPDQPL |
| | ISGCLYHKENTVPYALPANKTRTTFKTLSSMGGGGFNELRIEDKKGQEQIFLHAQR |
| | DWDENIEHDQKIRVGNERHDVVEKNSYTEFKAEEHHTVYEDRKVEARANDHLTV |
| | GVNQHIKIGTGQFIDAGQEIHLSSGMKVVLEAGAELTLVGGGSFIKIDGGGVTMSGP |
| | AININSGGGPGSGTGAAPLLPGVLKQADADKAGAVLTPAQINTLKRNAPFCEECEK |
| | CKAGACAI |
| SEQ ID NO: | MLDANATHITLTLEGASADLQVLSFTGREALNEPFRFDIELVSARPDLKLEELLHKP |
| 33 | GCLTFGATGEGKIHGLVYRIEQGDSGKTLTRYSISLVPQLAYLRHNHDQQIFQQLTV |
| | PKIIAQVLEDRGILADAYSFQLGAEYPERDYCVQYDESDLHFIQRLCEEEGIHFHFQH |
| | SSSGHKLVFGDDQTVFRKLKPVNYQQDSGMTADKPVIKRFNLRLETRTSRVSRRDY |
| | DFEKPKILPEGAAKSAFMPDLEDYDYPGRFTTRERGKFLSTRALERHRSDYKLAEG |
| | KGDEPTLTTGHFMTLAEHPRAEWNDMWLLLEIFHEGKQPQVLGENVTSDVTDNKS |
| | DFHQGYRNSFVATPWDAHYRPALEHPKPKVLGSQTAIVTGPGGEEIHCDQYGRVK |
| | VQFHWDRDGQADDKTTCWLRVASGWAGAAYGGIAIPRIGMEVLVTFLEGDPDQP |
| | LVTGCLYHKENVVPYDLPANKTRSTFKTLSSPGGKGYNEFRIEDKKGVEQIYIHAQ |
| | RDWDENIEHDQKIRVGNERHDTVEANVLSEFKVEEHRITHLDRKSEMRANDHLTV |
| | GVTQHVKVGTGQFVEAGTEIHYHAGDKVVIEGGMELTAKAGGSFVKVDAGGVTIS |
| | GAEVKANTGGAPGVGTGINILAPVIPIAAAIGSVGQLLERKIVPEKTEHDLDFLVTSQ |
| | ETGLPLKNFPYVIKTSSGKSIVGRTNDEGRTAKISSTEAETAVIEVYDDIPPINPGWD |
| | D |
| SEQ ID NO: | MSGYIPNPPKNYRNKGTDPVDIHAQRRAEYEKHGKEPASAREKIGIALRIGVFFDGT |
| 34 | GNNANNAAAGLLCGAHHPIAAQDIDASCKPFMKDPDSSYGNDTSNVQKLSDLYYA |
| | PQKAEGDGSQKQAFRMVYVEGIGTRSGMEDSTLGAGTGRGETGVAGRVQLSFSEI |
| | KLRIEGVLASHPESEITSLTFDTFGFSRGAAAARHFANEIARGKQGPLGDVMRSSAR |
| | GFSSTFNDQYKSSINMGFIGLFDTVPSIAGWSNLGNIKSPVATGIRLYLDRRYFSDVV |
| | QLTARDECRANFALSRVKPDHLEIVLPGVHSDLGGGYLEEAQENVLVSPMQSLDVS |
| | QNTDVVTTSIYRDAEIVKDQLLAKGWPAEMLEIVTPAALPLPNALQDRLSPRLKRV |
| | YAAVQLKRPVSGMLSRVYLRLMHQLAKEKGVRFKDIPDTPELAVPSELQALCDRF |
| | LAGDYSVTPQEEKLLKLKYIHTSANWNHPLGRRDGSGMSAVYINAPTADSIRVQHP |
| | HVPDWTLW |
| SEQ ID NO: | MPRSTDSNTTLSLTATSLSALYPESLSGEETLNNLGVQTLNGLNDGTSLTLTSAVAT |
| 35 | HVTTTLHNDAQLRPFDALVAEIRQLPADATAERYQLVLRPWLWWLTLASNNRVFQ |
| | NLTTSDIVTTIFKAHGFTDFKLSLTGSYTPREYCVQYGETDFAFVSRLLEEEGIFWFF |
| | THQDGKHTLVLGDSNDAFVQIPNGPKVKYLGQQLGERELHGIRSGQVCLQAVAGV |
| | YKATDYEFTTPTTSLYGQAEAVAGPRSIYEHPGGYNAKARGDALTKQRVDGLRSE |
| | EKRFVGESDCRWLIPGHWFTLDGHEDASLNIDWVVTRVIHDASHESYRNRFEAIPK |
| | ATPFRPQRLTPKPRMHPQTAIVVGKSGEEIWTDEYGRIKLQFPWDRDGKNDETSSC |
| | WVRVVLPWSGKGFGMQFVPRIGQEVIVTFIDGDPDRPLVTGCVYNGDNALPYALP |
| | ANQTQSGIKTQSSKGGGGFNELRFEDKKDAEEVFLQAQKDLKINVLNDTTATVGH |
| | DETLTVQHARTRTVKEGDETVTLEKGKRSVTIQTGSDSLDVKDSRTVKVGADQNH |
| | STGGNYTDKVTGDYSLTVDGNLTIKVSGTLTLQSGGSFTIKSGADLATSASTSITQK |
| | AGTAMTNQAGTSLDNKAGTTLTNDAGISLTNKGAASQTVDGGGMLTIKGGLVQV |
| | N |
| SEQ ID NO: | MLNDKESPFSLTLAEGGISLPVLRFSGHEALNQPFRFEIEVMGLAPAWSPGTLLHQA |
| 36 | AFLHLDDDHGIHGIIQSASCEHRATHRIAYQLVLMPHLQALEQHPVRRVFTQLNVP |
| | AILEQLLSEHHLPAHSYRIEMTVGHYPPRPFCIQYEETDLAFVQRLCEEEGIHYHFEH |
| | QPDGHVVVFADDSLSLPQQPTAIAFNTQIDAPATGLSSLFQRHEAVLPQIPAGVRER |
| | GHSITGQEAANHTLDSAFAPPGFLPTAHRHAAQRSRRLLERQRCRSRSIQGRSDCPR |
| | LLSGRLLQVMEHPVNAFNEQWLITDLRHQGQQPSILDPVPTVRRYHNDFTALPWST |
| | PFRPPPKQPRPGIPGYQPAQVLGAPGQPAQVDDQGRIAVRLWPDQPDASASEGLWL |
| | PVVMPHAGGGLPREDLPCAGSEVWVSFLDSDPDRPILCLDVCRPRPAQPKETEPDD |
| | DLLLDWLLNRSAPPR |
| SEQ ID NO: | MFSPANETHFSLTVEDYVCDLQVLSFTGTEGISQPFRFDLELVSENPDLDLEKLLHK |
| 37 | QAFLALDPQGSGIHGQIYRVAQGDAGKRLTRYKVSLVPQLQYLHHRTNQRIYQQM |
| | SAPKIIALILDEHGIKGNAYSFQLSQPCPDRDYCVQYDETDLHFVQRLCEEEGIHYHF |
| | QHSQKGHLLVFGDDQTVFPNLGQPTAYVQGSGMVAEEPVIKGFKLRLETRTSRTTR |
| | RDYDFEKPRLQMEAAYKPDGESTEPDLEDYDYPGRFIDRARGKFLSQRALERHRA |
| | DYRQAEGCGDQTRLVSGHFMEMSDHPRSEWNDLWLLTEIFHEGKQPQVLEESVTS |
| | DTTDNKDDFHQGYRNRFLATPWDVFYRPALEHPKPRVLGSQTAMVTGPKGEEIHC |
| | DQYGRIKVQFHWDREGLADDKTSCWLRVSSSWAGDRYGAISIPRIGMEVLVTFLE |
| | GDPDQPLVTGCLYHKENPVPYALPANKTRSVFKTLSSPGGGGYNELRIEDKKGAEQ |
| | IFIHAQRDWDENVEHDQKIRVGNERHDTVVKNTYTELKAEEHRTTISDRKVEVKAS |
| | DHLTVNQDQHIKLGTAQLTSAGKEIHLKAGDKMVIEAGSELTLQAGGSFIKLDGGG |
| | ITVVGPVVKINAGGSAGTGSGIAILMPLLPIPAPSAKAGNLMAPAQPGVLPTKPEPRE |
| | YFFDITLTDVPGDEGFPLAHTLWQIVQDGVDQPLLEGQTDENGRVNIDEPQRLKLS |
| | KAYAEAGPLWLCYPGQRV |

### Example 11—Importance of T6SS

This example demonstrates that T6SS is essential for contact-based killing of oomycetes.

### Construction of Hcp1 Mutant

Insertional mutants were created using a modification of the Kvitko protocol by DNA synthesis TWIST Bioscience South San Francisco, USA. A deletion construct of pDONR1K18 ms::ΔGOIx was first created by synthesizing the (~1000 bp) plus the first three codons of the gene and the downstream flanking regions of 1000 bp and the last three codons of the target gene. The forward flanking primer contains the 5′AttB1 sequence at the 5′ end and an additional 24 bp of the N-terminal sequence of the Spectinomycin gene. The downstream synthesized sequence contains 30 bp of overlapping sequence of the spectinomycin gene with no stop codon, the last four codons of the GOI and the stop codon, a 1000 bp of downstream sequence with the AttB2 sequence at the end.

For these constructs the spectinomycin gene (1008 bp) was also synthesized by TWIST.

The three fragments were stitched together using Genbuilder™ (Genscript, Piscataway, NJ) following the manufacturer's instructions. This product was then purified using a DNA precipitation protocol where a tenth of 3M sodium acetate, two and half volumes of absolute ethanol was added to the ligated products and frozen at −20° C. overnight. The next day the microcentrifuge rotor was chilled for an hour and the mixture span down for 5 minutes. The supernatant was carefully removed and the pellet was washed with 500 μl of 70% ethanol. The pellet was then eluted in 10 μl of autoclaved distilled water and this purified product was then cloned into the Gateway vector using BP Clonase II enzyme (Thermofisher Scientific, USA) transformed into competent Top 10 E. coli cells and selected on kanamycin plates.

HCP1_03593 was selected for gene replacement with the spectinomycin gene because it forms the shaft protein of the T6SS, and deletion of this protein would prevent the delivery of effector genes into the host cytoplasm. The deletion construct was built as follows. The Flank A, Flank B, and Spectinomycin (Spec) gene sequence were synthesized by Twist Bioscience. The three fragments (Flank A, Spectinomycin, and Flank B) were fused together in that order because they have the appropriate overlapping sequences using the Genbuilder cloning kit (GenScript, Piscataway, NJ). This fragment was then ligated into the Gateway plasmid pDONR1K18 ms via a BP Clonase II reaction and transformed into chemically competent Top10 cells and transformants selected for, on antibiotic media. The purified plasmid was delivered into the P. fluorescens strain LE6D7 by electroporation. Selection for integration of the plasmid was tested using Kanamycin. Selection for a double crossover event that integrates the spectinomycin gene into the operon was then facilitated by the use of sucrose as a counter selection pressure to facilitate excision of the plasmid and to force retention of the double cross over event.

To evaluate the potential role of T6SSin the virulence of these strains, one Hcp1 gene and 1 VgrG gene were chosed for mutation by gene replacement with spectinomycin. The HcP protein subunits form the shaft of this nanocrossbow ands have previously been targeted for deletion in functional assays of T6SS. VgrG proteins are at the top of the shaft and are required for secretion of effectors.

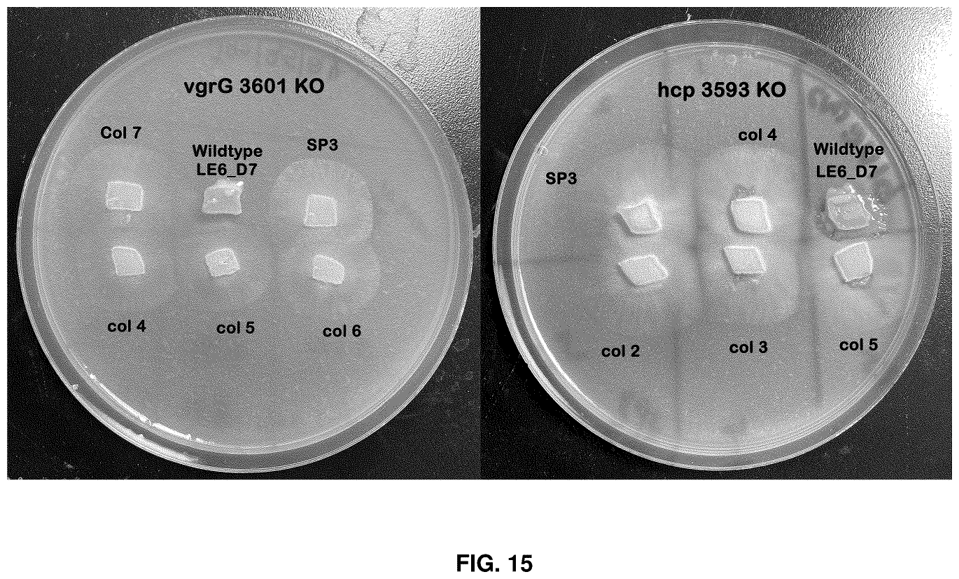

Hyph1 plugs of the pythiumstrain sp3 were ransferred to fresh V8 agair plates. Immediately adjacent to the hyphal plug a pipete tip was used to transfer cells of LE6D7 or the knockout mutants of Δhcp1LE6 or Δhcp1LE6. After 24 h the isolate LE6D7 had overgrown the plug and there were no viable hyphae (FIG. 15).

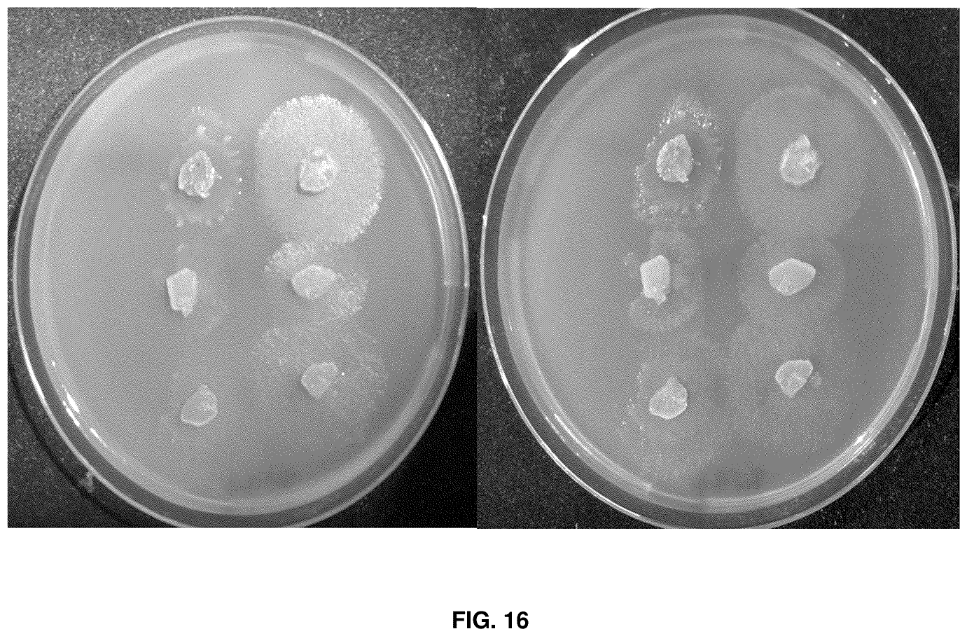

To evaluate the significance of a mutation in the vgrG_3601 gene the WT LE6D7 strain and the knockout mutant Δvgrg36011LE6 were tested against the six pythium strains from greenhouse locations shown in FIG. 10. In the case of WT, bacteria prevent egress of hyphae or spread quickly and killed hyphae. In the KOs, growth of hyphae sometimes overran the point of inoculation. The left plate in FIG. 16 shows isolates PY1 to Py3, the right plate in FIG. 16 shows isolates Py4 to Py6.

### Example 12—T6SS Essential Genes

The T6SS of LE6D7 and other strains which exhibit contact-dependent killing of oomycetes are distinct from T6SSs in previously described biocontrol agents isolated from soil. The genes of T6SS that are essential for contact-dependent killing of oomycetes, are distinct from other characterized biocontrol strains.

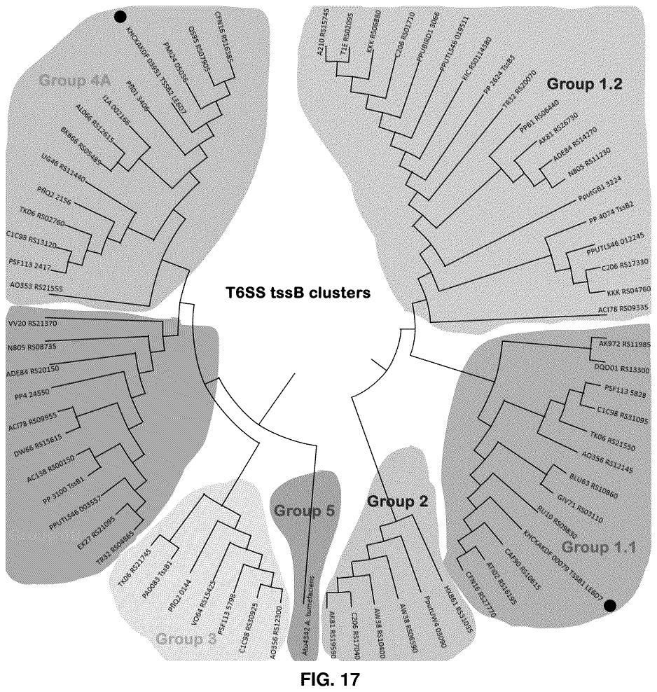

Comparison of different T6SSs has been made by doing a phylogenetic analysis of the conserved protein TSSB. This protein is essential for the delivery of effectors into the host cytoplasm. To compare the T6SSs of this isolate (LE6D7) to other recently characterized plant biocontrol agents, the TssB proteins of the type strain LE6D7 were used to retrieve related sequences from the Pseudomonas database to P. putida K20444, P. fluorescens F113, and P. fluorescens LE6D7, and LE6D7. The sequences were aligned with Muscle and Phylogenetic analysis was done using MEGA 11. A. tumefaciens was used as an outgroup (FIG. 17).

Sequences from P. putida were clustered with genes in Group 1.1, Group 2, and Group 4B, while sequences from P. fluorescens F113 were grouped with Group 1.1, Group 3, and Group 4A. In contrast, sequences from LE6_D7 clustered with other fluorescence sequences in Group 1.1 and Group 4A. Thus, the T6SS in LE6D7 are distinct from other biocontrol strains derived from soil systems with inhibitory activity against plant pathogens that include bacteria, fungi, and some oomycetes. These T6SSs and their associated effector proteins are specialized to target oomycete hosts.

### Example 13—T6SS Effector Proteins

Contact based killing results from delivery of effector proteins by T6SSs which disrupt the cytoskeleton structure of oomycete by conjugation of structural proteins.

To visualize the consequences of a physical interaction between the isolate LEGd7 and pythium hyphae, hyphal structures were examined by Scanning Electron Microscopy (SEM).

Samples were prepared as follows: a 0.2 cm² plug of P. dissotocum hyphae was grown on a V8 plate adjacent to two squares of nylon hybridization membrane that were applied to the surface of the agar. After 2 days of growth at room temperature, the hyphae had grown over the surface of the nylon membrane. One of the filters was kept as control while the other filter square was transferred into a microplate. One ml of a 1:100 dilution of LE6D7 culture OD₆₀₀=2.5 was added to the well and incubated at room temperature overnight. The next day the samples were fixed using glutaraldehyde 2.5% in 0.1M KH₂PO₄ buffer, PH 7.2 for 2 hours. The tissues were then rinsed twice in 0.1 M phosphate buffer for 15 minutes each time. Hyphae and hyphae incubated with LE6D7 were treated with osmium for 2 hours and dehydrated (following a gradient series of ethanol starting at 40-60-80-95-100-100-100%). Critical point drying was done with liquid carbon (iv) oxide using Samdri 780A Critical Point Dryer and the samples were then coated with gold-palladium (60-40) using a polaron sputter coater. The samples were observed under SEM secondary imaging using the Thermo Scientific™ Axia™ ChemiSEM™ Scanning Electron Microscope.

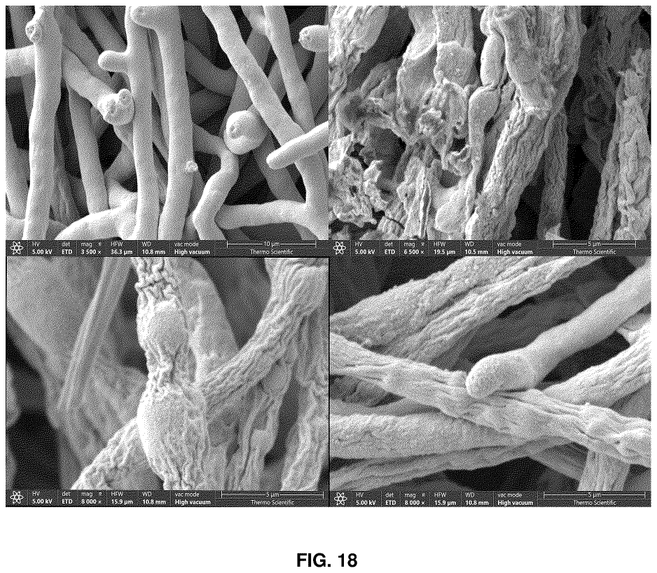

Incubation of pythium hyphae with the biocontrol strain overnight, a period long enough to result in to result in complete killing, resulted in profound changes in the appearance of hyphal threads (FIG. 18). Fixation of control samples showed the hyphal to have a smooth uniform appearance. In contrast, hyphae inexposed to LE6D7 had a shriveled or wrinkled appearance and some of the hyphae had burst open. Many of these samples showed the hyphae collapsing around large round structures within the hyphae. Control samples show smooth hyphae, while hyphae from competitive assays show wrinkled or broken hyphae that were exposed to LE6D7. Many of the infected hyphae show the cell walls collapsing around large round structures. The T7SSs of human pathogens like Vibrio cholerae, Pseudomonas aeruginosa, and Aeromonas hydrophila deliver effectors that disrupt the cytoskeletal proteins of actin or tubulin. The profound changes in hyphal architecture (wrinkling and the collapsing of hyphal cell walls around round masses) indicate that disruption of the hyphal cytoskeleton prevented the hyphae from initiating a defense response.

Certain embodiments of the compositions and methods disclosed herein are defined in these examples. It should be understood that these examples, while indicating particular embodiments of the invention, are given by way of illustration only. From the above discussion and these examples, one skilled in the art can ascertain the essential characteristics of this disclosure, and without departing from the spirit and scope thereof, can make various changes and modifications to adapt the compositions and methods described herein to various usages and conditions. Various changes may be made and equivalents may be substituted for elements thereof without departing from the essential scope of the disclosure. In addition, many modifications may be made to adapt a particular situation or material to the teachings of the disclosure without departing from the essential scope thereof.

1-13. (canceled)

14. A method of killing oomycetes, the method comprising contacting oomycetes with an effective amount of a pseudomonad strain to kill the oomycetes, wherein the oomycetes comprise a Pythium species.

15. The method of claim 14, wherein the Pythium species is P. dissoticum, P. oopapillim, or P. heterothalicum.

16. The method of claim 14, wherein the pseudomonad strain comprises Pseudomonas fluorescens LE6D7, Pseudomonas fluorescens LE6D8, Pseudomonas fluorescens LE6A6, Pseudomonas fluorescens LE6A8, Pseudomonas fluorescens LE5F1, Pseudomonas fluorescens LE5F7, Pseudomonas fluorescens LE5F8, Pseudomonas fluorescens LE5G2, Pseudomonas fluorescens LE5G8, or Pseudomonas fluorescens LE5H2.

17. The method of claim 14, wherein the pseudomonad strain is a Pseudomonas fluorescens strain.

18. The method of claim 14, wherein the pseudomonad strain is Pseudomonas fluorescens LE6D7 deposited as ATCC Accession Number PTA-127746.

19-25. (canceled)

26. A method of killing oomycetes, the method comprising contacting oomycetes with an effective amount of an organism having a type VI secretion system (T6SS) to kill the oomycetes.

27. The method of claim 26, wherein the oomycetes are Saprolegnia or Pythium species.

28-29. (canceled)

30. The method of claim 26, comprising adding an effective amount of at least one pseudomonad strain capable of contact-dependent killing of oomycetes into water of a hydroponic system, and cleansing the hydroponic system of Pythium propagules.

31. (canceled)

32. The method of claim 26, wherein the oomycetes are a Pythium species.

33. The method of claim 26, wherein the organism is a Pseudomonad species.

34. (canceled)

35. The method of claim 26, wherein the T6SS is characterized by including at least one of SEQ ID Nos: 1-37.

36. The method of claim 26, wherein the T6SS secretes at least one of SEQ ID Nos: 1-7.

37. The method of claim 26, wherein the T6SS is characterized by including at least one of SEQ ID Nos. 18-37.

36-37. (canceled)

38. The method of claim 33, wherein the Pseudomonad species comprises Pseudomonas fluorescens LE6D7, Pseudomonas fluorescens LE6D8, Pseudomonas fluorescens LE6A6, Pseudomonas fluorescens LE6A8, Pseudomonas fluorescens LE5F1, Pseudomonas fluorescens LE5F7, Pseudomonas fluorescens LE5F8, Pseudomonas fluorescens LE5G2, Pseudomonas fluorescens LE5G8, or Pseudomonas fluorescens LE5H2.

39-44. (canceled)

45. The method of claim 26, wherein the T6SS secretes each of SEQ ID Nos. 1-7.

46-51. (canceled)

52. A The method of claim 26, comprising introducing into a location an amount of a cell suspension, supernatant, filtrate, cell fraction, or whole cell broth derived from a Pseudomonas fluorescens LE6D7 deposited as ATCC Accession No. PTA-127746 effective to kill the oomycetes in the location.

53-54. (canceled)

55. A biological anti-oomycete product comprising:
a stabilized suspension of a Pseudomonas organism having a type VI secretion system (T6SS) characterized by one or more of SEQ ID Nos. 1-37; and
a cultivation medium.

56. The biological anti-oomycete product of claim 55, wherein the cultivation medium comprises Lysogeny broth.

57. The biological anti-oomycete product of claim 55, wherein the biological anti-oomycete product is derived from a Pseudomonas fluorescens LE6D7 deposited as ATCC Accession No. PTA-127746.

58. The biological anti-oomycete product of claim 55, wherein the Pseudomonas organism is selected from the group consisting of Pseudomonas fluorescens LE6D7, Pseudomonas fluorescens LE6D8, Pseudomonas fluorescens LE6A6, Pseudomonas fluorescens LE6A8, Pseudomonas fluorescens LE5F1, Pseudomonas fluorescens LE5F7, Pseudomonas fluorescens LE5F8, Pseudomonas fluorescens LE5G2, Pseudomonas fluorescens LE5G8, and Pseudomonas fluorescens LE5H2.


SEQUENCE LISTING (37 sequences)

SEQ ID NO: 1 - protein, 933 aa, Pseudomonas fluorescens
MTETTNKIQKWSYPLKVGTAEATDPQQFYKALAKAKDGYYPLGANGLWHGGVHFDEASGLVKDLTEVRCIADGEVVAYRIDEKYPTSDFGSTHSVYSTGFVLVKHRLELPAPPAPAAGAAPASSPVAGPSLTFFSLYMHLLDWEGYKANPTLKDRPGFWGKGLYEVKANAPDKPLGIRMRSGNAGHFPVLAVLPRGTTVVTQPAPANQMWVAVISVSPEIAGLPAGGWVYKGQLKDLGGGKYFVGNEAQDPVPGGAQHGANIRGAHTSGLPLSHLSAGAQVRLGDEATPNNFRKLAEIVSGQATPALAPGADGKLPGFIWLQSLTPKSEPHSPMGDVVVLSPTYKIKAGEILGHVGKYQNHSDAAPKNLLHLEVFSCEDVKAFTEQSKAKAAGAPVAEKSIVKIPVGTKLITHVQGMNATNPPKASDAGNDVGYDFYVPVGLLETLPADKKIKQTVTMGQSTTTTYWWRLDGLLGDKDGNGIDGWFAEQDIVISRHSPFEWNGFDFIEETTSNADHFAAFLHAQENLSEQEREGYLPNVEAAIAGSVNEKLYKILDRDGDKKIAPTEIAEALNKPWFSQPISQMVTRYENEWDFKKDKWDALDEIIGHSDSEPHEEWVEEKARIEKLSWWSKLLGQHGITSNASVQHIHPIGLISSFAHAGGCSCSDTITKDQMKLIDPSATQANIDKYTDLLGEMFERSGVAKCISKAHILAQMLHESGHLHYTVEGLDPDKPLPTYHPYIGRGLMQITHRVNYEAYGQFAGESFIGAPNYNKLGQLPHSVLSAGWYWVDYKKILTHSDADDFIYCTILVNGGLNHYDERLLFLNNALKALDIKGCAKLNKSGAYDLLDSKAYNKAKFSFAWGLWSDPAGGKAGKTPDAAQAIIGYKRFLDLYNSDSSVSGNTNTTYYASGRIASVAKQYAEARIVALGGTL

SEQ ID NO: 2 - protein, 195 aa, Pseudomonas fluorescens
MEVFMGTIQPFAFNFAPSGWALCNGQILGISQYQALFALLGTYYGGNGTTNFQLPNLQGRVPVAQGTGLGLTPRVIGQVYGTENVTATIANMPNHTHAMTGLTANTALSLAVPASNPATVPTATNSYIGASGGGPGSANIYSDAQGATPVPLKGVTTTVTGDISSTGGSQPLPILNPALVLNFSIALNGLFPSRN

SEQ ID NO: 3 - protein, 130 aa, Pseudomonas fluorescens
MAKNKPLTTAQKPLTPKADTASAKVAVDDSRRLKEIRKLVEANNQSKIDTNTVICQIYMESHFDPEAGRGKHSARGLMQMQEPAVKQVYKYRKKKELGRMPNQAQTDEAFSAGAAFYASPSIWDEAENIK

SEQ ID NO: 4 - protein, 348 aa, Pseudomonas fluorescens
MPLPSAPQQRPVINVLSPHNPNHLCILSVVLGVIGQHVTTKSPEEVQAYTHPGESTIYVAANKNGESLIAACEVLLTAIHPGGSNALMEAARILHVLFSETDRVINQNIPEYELQESWLKSNQVGNKNGNWATDENSKLVRWKFLDRAPIIPDTKLYVTNMPSKTAEEKAKVAEKILELTYNPRLNTKQLNNLLNLVKAFKEQKPLPRTVVLSPITKITNTPPTPHALQYVENDGYHAEISLMRALIIGSGFKPVIKGNLGGKKAACAKCSAWFSKVKTLSANQIDPSFPNEAEFGNLRPQRQSPTNWAAPKFSPHVFSSTDFTVFKTVYEGAGKVTTSAEEELMEFT

SEQ ID NO: 5 - protein, 208 aa, Pseudomonas fluorescens
MPLNPEYKSTTVNVNGSNVTVPLYAKATLTSTNMTGGSGPDQSLRPPGFVSGTCPEHHQRGHLIGNKLGGSGTDLRNLVTLTEGSNHPIMYEYEAMVYEYVKKNPGIEFVYQVTAQYDTSRYLVAQVAPGGSTSGAANNPYCPLPCPESLRIDFFYAEAPGKLNYPLIYRVLTEHGEGWNTGPLYILNGVYKFHEGSPKHVAQGCWAS

SEQ ID NO: 6 - protein, 180 aa, Pseudomonas fluorescens
MAITPLDLQQDDKQLKGRLQDGQLDGPLNIKDDGRKQADLNYSQGELQGTSLLYHPNGKVSAQMPFVRDKLQGIASFYAPEGWLQRKASYRRGLLHGEAFNYFPDGQVAEAEFYRDGVREGRYQRFHPNGKPAVDARYLNGQLMEPEQGFAEDGRPLDADGKPISRVRWWFRKWTDPQQA

SEQ ID NO: 7 - protein, 131 aa, Pseudomonas fluorescens
MGCPQVCASATLQCSFGAAPAVLNVLPVNRTLTGGMPAANIMDHIPLVNVTTFGMCMSMANPMVAAATAAALGVLTPMPCIPATATPWIPGGAPTLLLGGMPAIDANSTLMCNWAGVIKIVMPGQMQMLIP

SEQ ID NO: 8 - protein, 250 aa, Pseudomonas fluorescens
MRRSAKNASAARVVSVQPEQWLKDVPLKPSEQLFAIFSSASAAEPLKAWPLKAQMPKPVWAETIYAEWDAVMPYVGIVDAGSEFLDWVATTESRDWGWLAVSSAGLEAVVEHFRSLTQVLMPDGKVVFFRFWDGRYLLPILESSEVDAGQLLPVLTRGFINGQAVEIGGRAGVSGREFPWWSVPEKLLTQFGEDARINNALQWLSEEQPALFEAFPADVLRCKVVRFFAVSASDESSASALLEYLRDESE

SEQ ID NO: 9 - protein, 264 aa, Pseudomonas fluorescens
MSVSTPGQRAQWLLLDIAQAPQAVQTLRQGFAGVHSLKLFDGTEFQPVSDQGPWLIDLRDSPALSALCHADPLTWQGLLLGSEASASLLREHLQRMLTVSVGLNHRALLNFYNRQTASYFFDACNARQLSCWLGPIAWLRWFGGTWADLAGGSQGWQQLRNPGLAVEPLRIEQSLTRQQRERLHRCLLDQHVWRWSQATGNDYRLMSSFQEQGLELGFSEQALLDDWLWLRLQHPRAELTPLPQGLPPRERLELLRRRWLNDPS

SEQ ID NO: 10 - protein, 293 aa, Pseudomonas fluorescens
MLNPEWPLENGLPEGLPWNGTVGLLLDGVSVEKLPQHLYQWTDNPEFEPLYLGTRWAKLGDISPCLVRIKAQNDPILAKFLNASRQEWGHLVFSDQPWDQLVAHFRWLTSVMHPQGEEVLLRVADPAVTHALLSHAETIKDPTLFGPCTQVVTADAALGCWHINRRQGITSEPNHSKRYRLSDEQLSQLDEVNFRNVVMRLDEHMHEYFPSYQAQSTPPQRWEHLHALASTSYDRGFNTELDITLYANIHGFLGERALEEHPDLDAILKTPSEQTPAQRLERVADMAQERAAG

SEQ ID NO: 11 - protein, 119 aa, Pseudomonas fluorescens
MSKTVIPPLEDPVSPYEFPDSRKLHDAAERALDYYLTPAARIMATPYTPNDMFMVNPQTDTESLLANACESLASATVMLGDFAGLLEGPNRKTLLGIAQVVMLGELAVNQALDNLVPKE

SEQ ID NO: 12 - protein, 513 aa, Pseudomonas fluorescens
MSGYIPNPPKNYRNKGTDPVDIHAQRRAEYEKHGKEPASAREKIGIALRIGVFFDGTGNNANNAAAGLLCGAHHPIAAQDIDASCKPFMKDPDSSYGNDTSNVQKLSDLYYAPQKAEGDGSQKQAFRMVYVEGIGTRSGMEDSTLGAGTGRGETGVAGRVQLSFSEIKLRIEGVLASHPESEITSLTFDTFGFSRGAAAARHFANEIARGKQGPLGDVMRSSARGFSSTFNDQYKSSINMGFIGLFDTVPSIAGWSNLGNIKSPVATGIRLYLDRRYFSDVVQLTARDECRANFALSRVKPDHLEIVLPGVHSDLGGGYLEEAQENVLVSPMQSLDVSQNTDVVTTSIYRDAEIVKDQLLAKGWPAEMLEIVTPAALPLPNALQDRLSPRLKRVYAAVQLKRPVSGMLSRVYLRLMHQLAKEKGVRFKDIPDTPELAVPSELQALCDRFLAGDYSVTPQEEKLLKLKYIHTSANWNHPLGRRDGSGMSAVYINAPTADSIRVQHPHVPDWTLW

SEQ ID NO: 13 - protein, 124 aa, Pseudomonas fluorescens
MSFDIFPTLEHEIRLSPPERAVTLIAACNTNEIGRFNVRETVYQTLIGSRPEQRKTQSWIFTSSVIRAQTDSRDRVMVFVSVKKKYLKKVSDSLNGWSCPHGTPMQVIKVQHGIASSQLVFANS

SEQ ID NO: 14 - protein, 153 aa, Pseudomonas fluorescens
MQFKNLAVPLLGLMWTLQAFAETSTFSPTQGVEAALVLEGSTLNIAVKGETHNESRTIDFQAENELHVQVDDFNFDGVKDFAIWQLDDGMGTYDYYRVFIYQVKTGTFEELQPDCGDGFVNLRVDKKRKALLSTYWEMNIAKQCVTRFAKRKA

SEQ ID NO: 15 - protein, 310 aa, Pseudomonas fluorescens
MIKVAVFFILTFMATAASASSGCEADLNGDGICDPYSVSPLEDDGTISRITIDIGGSNKSVSGNFELGDGGLSVGYLPSEFSLLLDFYTRNTDLTQFSFKWSSAQQDWVLYKKSTWVEPSRDEKYTLSGEKAPIELLFPQQFNVQRIACCTLFSQFSESAPNFSYLSDETQLAEIRKDFKYILSKLPQGEKGELFYGLDDSGNKVRRNIPQELVYELTLIVADDNVGPLNDYAYYLYRSKNNVLAALLLREIHKKFPERVVATLNLADAYWDIGMRSDACPLYKEYIAQMTKNGKGGRIPQAAKSRENCN

SEQ ID NO: 16 - protein, 140 aa, Pseudomonas fluorescens
MSNYYRIAMCLFVHAFGCVAYVFLNNAVVHAYKHLNGGFTTRGVAIGIASYAMFYIFLGVNFIAALIPSLVAKLVILSLMVGFILLWMLPDNPLRALFYGVAQGCVTLLAILASQVIELRWVLRNIAGRIQPNQPESAIQ

SEQ ID NO: 17 - protein, 148 aa, Pseudomonas fluorescens
MSARLFLTIGFALLAGCSFFGPKVDLDSLTLDVAPKANDDTPIAVDFIAVNDPDLLKQLSGISARQWFAEREQYQRDYRQLMSVWGLELVPGQFIDRQPFPLGGKRAAGLLVFASYNTPGAHRLRLDDQSDAWLKFDSREMSLVSKEN

SEQ ID NO: 18 - protein, 171 aa, Pseudomonas fluorescens
MATPAYMSVTGEKQGLITAGAFTADSVGNTYQEGHEDQVMVQAFSHDVIIPRDPQSGQPTGQRVHKPVIITKVYDKASPLLQAALTSGERMSEIVIQWYRTSAQGTQEHYYTTKLEDAIIVAINNKMHNCQDPSNAHFTHLEEVQFTYRKITWTHEVSGTSGSDDWRAPVV

SEQ ID NO: 19 - protein, 171 aa, Pseudomonas fluorescens; identical to SEQ ID NO: 18

SEQ ID NO: 20 - protein, 165 aa, Pseudomonas fluorescens
MDAIILDLGGDIKGDSLLEGYADKIEVMSYSHNVAMQVTNDVSNSERTSGKPHVGEFTLTKFVDTSTPSLNEYCCAGKPIPEAKITIGRNAAEGSGQLLPFIIYTLTNVVISNVSVSGGTGGKPVETLSLNFTKIKWELTAQKDDGTKEGTAASTWDMAANKLVS

SEQ ID NO: 21 - protein, 161 aa, Pseudomonas fluorescens
MANPAYMTITGKTQGLISAGCSTPESVGNKYQKAHTDEIMVFALSHEMRRDNNLGKAVHQPVIITKAVDKSSPLLAQAHSNSEELECTISLYRTSPQGQQEKFYSISLDGAVLAELSQEVPHVILQNDAQPQEQLAIRYRGISWVHHIAGTTGHTSWGSQD

SEQ ID NO: 22 - protein, 174 aa, Pseudomonas fluorescens
MSGKPAARVSDPTACPLPGHGTNPIAAGSGDVFFDGLPAAREGDASACGGAMVGDLATTVLINGKPAATVGSVGSHGNKVTAGSGTVIIGNSHSPAPFVPPLPVEIQWPFSQHFVVRNPRTGAPVADRPYTLRTASGKEVRGVTDAQGRTRPIASHLAESVTLIVEEQTSLVIA

SEQ ID NO: 23 - protein, 139 aa, Pseudomonas fluorescens
MAKPAARKTDPSSCPLPGHGTNPIATGSPDVFFDGLPAARQGDTCTCGSALSSGLSSTVFINGKNAATIDTGGTHGSIVIGGSGTVIIGDTHTPCDFVPPTLLAGHARWIGFRIPADESYEGLSCTAHFEDGSTLPGVF

SEQ ID NO: 24 - protein, 175 aa, Pseudomonas fluorescens
MAKPAARLSDLNACPITGHGTNPSTSGSPNVNINGMPVLRVGDTTACGDSVTEGIGNILINGKPIAFLGSATAHGGMIITGSGDVFVGTQVGSAPFSPIVTVPKHSERFQLVDETTGEAIPDMLYCIETGDGQRLVGHTDNHGNAARVFTADPTSIVVQWGKEAAAHLDALGIDY

SEQ ID NO: 25 - protein, 106 aa, Pseudomonas fluorescens
MSGKPAARVTDPTACPLPGHGNNPIVSGSPDVFFDGLPAARMTDKSACGSPITGGVSATVFINGLNAAMLDSTGGHGNVVVGGSGTVIIGQSGGGAAFSGLLPMPV

SEQ ID NO: 26 - protein, 684 aa, Pseudomonas fluorescens
MFNPANETHFSLTVEDYVGDLQVLSFTGIEGISQPFRFDLELVSENPDLDLEKLLHKQAFLALDPQGSGIHGQIYRVAQGDAGKRLTRYKVSLVPQLQYLHHRTNQRIYQQMSAPKIIALILDEHGIKGNAYSFQLSQTCPDRDYCVQYDETDLHFVQRLCEEEGIHYHFQHSQKGHLLVFGDDQTVFPNLGQPTAYVQGSGMVAEEPVIKGFKLRLETRTSRTTRRDYDFEKPRLQMEAAYKPDGALDSKDAEPDLEDYDYPGRFIDRARGKFLSQRALERHRADYRQAEGRGDQTRLVSGHFMEMSDHPRSEWNDLWLLTEIFHEGKQPQVLEESVTSDTTDNKDDFHQGYRNTFLATPWDVFYRPALEHPKPRVLGSQTAMVTGPKGEEIHCDQYGRIKVQFHWDREGQADDKTSCWLRVSSSWAGDRYGAISIPRIGMEVLVTFLEGDPDQPLVTGCLYHKENPVPYALPANKTRSVFKTLSSPGGGGYNELRIEDKKGAEQIFIHAQRDWDENVEHDQKIRVGNERHDTVVKNTYTELKAEEHRTTISDRKIEARMDDHLTIGESQHVKLGTAQLTSVGKEIHIKAGDKIVIEAGTELTILGGGSFIKLDGGGVTVVGPVVKINAGGSAGSGTGIGIKPPVLPGAADKDKAGSLMDQALLNAPEEQAKRKPKRMLNFSG

SEQ ID NO: 27 - protein, 1113 aa, Pseudomonas fluorescens
MSGAVSSARFTLQIPAVRNDFKVLAFEGTETISTLYAIHVELVSEDPDFDMEGLLGQPAFLQFGLNGEGIHGRIDDVLAGESGKRLTHYRLILVPSLHYLQFSHDQRIYQGQTVPQIITQTLKRHGILADAFTFHVQPLAARDYCTQYDESDFEFIQRVCAEDGIAWHHQHSAQGHLLVFTDDSVFLPTLRATPYRRDSGMVPEYPVVSRFSLRAATRTSRVTRRDYDLRRPTLLIESRFSAEFTPTLEDYQYPLPLANEKRGKQLARQALERHRADYEMAEGQSNQPTLRCGHLLELTEHPRQKCNDLWLLLGISHTGRQPQVLEESVSSETQSADGFTQGYRNTFHAIPAEVVFRPPLPARRPPLVSQTARVTGPKGEEIYCDEFGRVKVEFHWDRTELNSERSSCWVRVSSSWAGNGFGVVTLPRIGTEVVVTFVEGDPDKPLITGCVINKVTPAPYKLPEHKTRTVLRSRSSPDTGGYSEFTIEDRAGLELVYLRAQRDMERQVLHDSRLAVGRDRWESIQGSSQTTAGKIITVEAGQQVQIKAGASVVLDAGASITLKAGGHHIVIDSGGIFSSTEMVAGGKTSASGAADHPEAAMAGTLAAGPATASTQAAEEGELEEEEEEVELEDELPAGITLRIGVFFDGTGNNLFNSEQVKGCYARDVNLEEEAEDIRQFCQMHGYDGQGNVPDNSYGNDASNVARLYELYRDDQGRQLAKEETIAYIPVYLEGIGTSADKDDSVFSQMTGTGAQGVLARVKQSPTSIIPGIRLFESANPTLKVESVQFDIFGFSRGAAAARHFANEVMKGEQSPLAQLLPADSSLFLESFSWRANIDVSINFIGIFDTAAAIGSMADGDFSVHDANNPGVNLYLAPDIAKKVVHLVARDERRHNFSLNSAGNADIVLPGVHSDLGGGYLPNLVERVLLSKPRCSRDVDFNTPSSSTNAYRLAEQELGRLQDQLHFYGLTLQVKTWAVETASNVKGDRRKSKNVYAAVYSERVVRNDLSLIYLRIMRELANRHGVEFETINQESQSYALPGELKGIARKLMMFALGESRSLDLSLNEHALLAQRYIHLSSNWNAAKGLNETGLSILFINRPADQSVRVVHPNA

SEQ ID NO: 28 - protein, 689 aa, Pseudomonas fluorescens
MFNANARLRLITDAFKHDLQVLSFTGTESISQPYSFDVKLVSPRPDIDLPGLMHRQAFLAFDDHGHGVHGQIQHIGKDDIGYRLTQYHLTLAPCLTNLGHHFNQRVFQHLSVAQIIGQILQEHGIHADGYLFQIGQALPDREYCVQYNESDLHFIQRLCQEDGLHYHFRHSLDRHLLVFGDDQTVFPRLARPTPFKPRNAMVADRPVIHRLDCGLNTRTSRASRRAYDFERARIVLESDARIPNENCQPDLEDYVYPGRVLDREHGKLLARRILERHRSDERVAQGDSDEPALVSGHFLSLSEHPDPALNDLWLLTEIEHEGQQPQVLEESGSDIAVSDKSDFVQGYRNHFEATPWDVIYRPPLRYDKPSIGCTQTAVVTGPEGEDIHCDSYGRVKVQFFWDRKGRHDDKSSCWLRTTTNWAGNAHGSVIIPRVGMEVLVTFLNGDPDHPVISGCLANSANPVPYELPAHKTRSVFRSRSTPDSNGFNELMIEDRAGQELIYLRAQRDLQQKIEHDSHLDIGNQRRETIKGNSVSVLHAEEQRTITGDRKTHLKASDYLHVSQNSHTRIGQSLTVEAAGQVCLSAGEHLVLEAGKSISLKVGGEHFVLDHGGLFGSSDLLIGGAPAAFLRAPILLPDSVEDLAPSTPLPPLVAPSQTALMADSKTLGADFCPICEACRGGACLIEGAAA

SEQ ID NO: 29 - protein, 660 aa, Pseudomonas fluorescens
MFAPANQPRFTLTVEGALFDLKVLEFTGKEAISQPFRFDLELVSERPDLDLESLLHCQAFLSFDEDGSGIHGQIYRVGQGDSGKRLTRYHVSLVPRLAYLGHRINQRIFQHQSVPQIVTQILKDHAILRDAFEFRLGSDYPPREYCVQYAESDLAFIQRLCAEVGIHFHFQHSPDGHLLVFGDDQTVFPRLAEPTLYLPGSGMAASAPAIKRFTVRVETRTSVVTRRDYDFTKPRLALQSWVESDQRPVLEDYHFPGQFTDRASGKQLAQRTLERHVADYRQAEGRSDQSALVSGHFLQLAEHPRQDLNDLWLLTAIEHHGRQPQVLEESVTSEGDEFQGYRNTFLATPWDVFFRPPMGPEKPRMLGYQPAVVTGPQDSEIHCDEYGRVKVQLAWDRDGELNEHSSCWLRVASGWAHDRYGSVLIPRVGMEVLVGFIDSDADKPLVMACLPNAATPVPLDLPADKTRSIFRSQSSPGGGGYNELRIEDRKGAEEIYLRAQRNWTQHVLNDQQVQVDNQRSVVVTGLAKHELKADEQRITHGQRQTEVKQDDHLTVTGDRHIRVSNQAINASAQFHVSAGQQVVIDGGASATIQAGGQWINIGPGGIFSSVPIVVGGAPMAAMSAAPTVPGLPEKLVAAPAVILTAAQIMSLKGDAPFCEE

SEQ ID NO: 30 - protein, 449 aa, Pseudomonas fluorescens
MFDPADEPSFRLDVAGLSDSLEVLAFTGCEAISEPFAFEIDLLVDDPHLDLAGLMYRSARLCFGPCGNGVHGQLHSLVQHEQGRDARLCRARLGPRLSCLGLRYSQRIFSDRSVPQILDQVLREHGISGTRRRFDLQGAYPPRTFCTQYGESDLQLVQRLCGQARIHYHFEHGNRGHCLVFGDDPARLPHAANLRFDCGDGEPSPTVRRWQLGEHAGLYAEGSRRTRTARGHSDSPTLRSGHWLTITGQPLAEANGHWLVSRIEHRADQLLEPPYSNRIFAADRLPVFRSPIEHLGARMRSPQRAWVVSVEEAQPDAVRPVAVQFDWLYQGEGARPSHCWLPLAPALADTPMASLQDGAEVVVSFLEGNPEQPVISGVLQIPALTKAIEDDASPPLPERLASAGLPQWLKAAEPLLLLCLIPGGGSYRHCAASLCSCRLVGGLKTSDAR

SEQ ID NO: 31 - protein, 680 aa, Pseudomonas fluorescens
MFAPANETHFALTIEGLSADFQVFTLTGREAISQPFVFEVELVSEQPSLDLETLLHKPAFLQLSPDGSGIHGLIYRAAQGDSGKRLTRYSVTLRPQLAYLAHRINQRIFQNLSVPKIIGKVLEEHGIQGNAYAFQTGSIYPDRLYCVQYDESDLHFIQRLCEEEGIHYHFQHSATGHKLVFGDDQTVFKKLAPVAYQQDSGMVASNPVIKRFDLRLETRTSRTTRRDYDFEKPRITLESENRGDALPDLEDYDYPGRFVDRERGKHLAKRALERHRSDFQLAEGKSDQPLLVSGHFLALKEHPKAKWNDLWLLTEVHHEGKQPQVLEESVTSDTTALKDDFHQGYRNRFQATPWDVPNRPPLRHPKPRILGSQSAVVTGPKGEEIHCDEYGRVKVQFHWDREGQADDKTSCWLRVSSAWAGAQYGGIAIPRIGMEVLVTFLEGDPDQPLISGCLYHKENTVPYALPANKTRTTFKTLSSMGGGGFNELRIEDKKGQEQIFLHAQRDWDENIEHDQKIRVGNERHDVVEKNSYTEFKAEEHHTVYEDRKVEARANDHLTVGVNQHIKIGTGQFIDAGQEIHLSSGMKVVLEAGAELTLVGGGSFIKIDGGGVTMSGPAININSGGGPGSGTGAAPLMPGVLKQADADKAGKLLVPAQRQALMQKKPICAVCEKAKLEAQNA

SEQ ID NO: 32 - protein, 680 aa, Pseudomonas fluorescens
MFAPANETHFALTIEGLSADFQVFTLTGREAVSQPFVFEVELVSEQPSLDLETLLHKPAFLQLSPDGSGIHGLIYRAAQGDSGKRLTRYSVTLRPQLAYLAHRINQRIFQNLSVPKIIGKVLEEHGIQGNAYEFQTGSIYPDRIYCVQYDESDLHFIQRLCEEEGIHYHFQHTATAHKLVFGDDQTVFKKLAPVAYQQDSGMVASDPVIKRFDLRLETRTSRTTRRDYDFEKPRLTLESENRGDALPDLEDYDYPGRFIDRERGKHLAKRALERHRSDFQLAEGKSDQPLLVSGHFLALKEHPKAKWNDLWLLTEVHHEGKQPQVLEESVTSDTTALKDDFHQGYRNRFQATPWDVPNRPPLRHPKPRILGSQSAVVTGPKGEEIQCDEYGRVKVQFHWDRDGLADDKTSCWLRVSSAWAGAQYGGIAIPRIGMEVLVTFLEGDPDQPLISGCLYHKENTVPYALPANKTRTTFKTLSSMGGGGFNELRIEDKKGQEQIFLHAQRDWDENIEHDQKIRVGNERHDVVEKNSYTEFKAEEHHTVYEDRKVEARANDHLTVGVNQHIKIGTGQFIDAGQEIHLSSGMKVVLEAGAELTLVGGGSFIKIDGGGVTMSGPAININSGGGPGSGTGAAPLLPGVLKQADADKAGAVLTPAQINTLKRNAPFCEECEKCKAGACAI

SEQ ID NO: 33 - protein, 731 aa, Pseudomonas fluorescens
MLDANATHITLTLEGASADLQVLSFTGREALNEPFRFDIELVSARPDLKLEELLHKPGCLTFGATGEGKIHGLVYRIEQGDSGKTLTRYSISLVPQLAYLRHNHDQQIFQQLTVPKIIAQVLEDRGILADAYSFQLGAEYPERDYCVQYDESDLHFIQRLCEEEGIHFHFQHSSSGHKLVFGDDQTVFRKLKPVNYQQDSGMTADKPVIKRFNLRLETRTSRVSRRDYDFEKPKILPEGAAKSAFMPDLEDYDYPGRFTTRERGKFLSTRALERHRSDYKLAEGKGDEPTLTTGHFMTLAEHPRAEWNDMWLLLEIFHEGKQPQVLGENVTSDVTDNKSDFHQGYRNSFVATPWDAHYRPALEHPKPKVLGSQTAIVTGPGGEEIHCDQYGRVKVQFHWDRDGQADDKTTCWLRVASGWAGAAYGGIAIPRIGMEVLVTFLEGDPDQPLVTGCLYHKENVVPYDLPANKTRSTFKTLSSPGGKGYNEFRIEDKKGVEQIYIHAQRDWDENIEHDQKIRVGNERHDTVEANVLSEFKVEEHRITHLDRKSEMRANDHLTVGVTQHVKVGTGQFVEAGTEIHYHAGDKVVIEGGMELTAKAGGSFVKVDAGGVTISGAEVKANTGGAPGVGTGINILAPVIPIAAAIGSVGQLLERKIVPEKTEHDLDFLVTSQETGLPLKNFPYVIKTSSGKSIVGRTNDEGRTAKISSTEAETAVIEVYDDIPPINPGWDD

SEQ ID NO: 34 - protein, 513 aa, Pseudomonas fluorescens; identical to SEQ ID NO: 12

SEQ ID NO: 35 - protein, 669 aa, Pseudomonas fluorescens
MPRSTDSNTTLSLTATSLSALYPESLSGEETLNNLGVQTLNGLNDGTSLTLTSAVATHVTTTLHNDAQLRPFDALVAEIRQLPADATAERYQLVLRPWLWWLTLASNNRVFQNLTTSDIVTTIFKAHGFTDFKLSLTGSYTPREYCVQYGETDFAFVSRLLEEEGIFWFFTHQDGKHTLVLGDSNDAFVQIPNGPKVKYLGQQLGERELHGIRSGQVCLQAVAGVYKATDYEFTTPTTSLYGQAEAVAGPRSIYEHPGGYNAKARGDALTKQRVDGLRSEEKRFVGESDCRWLIPGHWFTLDGHEDASLNIDWVVTRVIHDASHESYRNRFEAIPKATPFRPQRLTPKPRMHPQTAIVVGKSGEEIWTDEYGRIKLQFPWDRDGKNDETSSCWVRVVLPWSGKGFGMQFVPRIGQEVIVTFIDGDPDRPLVTGCVYNGDNALPYALPANQTQSGIKTQSSKGGGGFNELRFEDKKDAEEVFLQAQKDLKINVLNDTTATVGHDETLTVQHARTRTVKEGDETVTLEKGKRSVTIQTGSDSLDVKDSRTVKVGADQNHSTGGNYTDKVTGDYSLTVDGNLTIKVSGTLTLQSGGSFTIKSGADLATSASTSITQKAGTAMTNQAGTSLDNKAGTTLTNDAGISLTNKGAASQTVDGGGMLTIKGGLVQVN

SEQ ID NO: 36 - protein, 468 aa, Pseudomonas fluorescens
MLNDKESPFSLTLAEGGISLPVLRFSGHEALNQPFRFEIEVMGLAPAWSPGTLLHQAAFLHLDDDHGIHGIIQSASCEHRATHRIAYQLVLMPHLQALEQHPVRRVFTQLNVPAILEQLLSEHHLPAHSYRIEMTVGHYPPRPFCIQYEETDLAFVQRLCEEEGIHYHFEHQPDGHVVVFADDSLSLPQQPTAIAFNTQIDAPATGLSSLFQRHEAVLPQIPAGVRERGHSITGQEAANHTLDSAFAPPGFLPTAHRHAAQRSRRLLERQRCRSRSIQGRSDCPRLLSGRLLQVMEHPVNAFNEQWLITDLRHQGQQPSILDPVPTVRRYHNDFTALPWSTPFRPPPKQPRPGIPGYQPAQVLGAPGQPAQVDDQGRIAVRLWPDQPDASASEGLWLPVVMPHAGGGLPREDLPCAGSEVWVSFLDSDPDRPILCLDVCRPRPAQPKETEPDDDLLLDWLLNRSAPPR

SEQ ID NO: 37 - protein, 746 aa, Pseudomonas fluorescens
MFSPANETHFSLTVEDYVCDLQVLSFTGTEGISQPFRFDLELVSENPDLDLEKLLHKQAFLALDPQGSGIHGQIYRVAQGDAGKRLTRYKVSLVPQLQYLHHRTNQRIYQQMSAPKIIALILDEHGIKGNAYSFQLSQPCPDRDYCVQYDETDLHFVQRLCEEEGIHYHFQHSQKGHLLVFGDDQTVFPNLGQPTAYVQGSGMVAEEPVIKGFKLRLETRTSRTTRRDYDFEKPRLQMEAAYKPDGESTEPDLEDYDYPGRFIDRARGKFLSQRALERHRADYRQAEGCGDQTRLVSGHFMEMSDHPRSEWNDLWLLTEIFHEGKQPQVLEESVTSDTTDNKDDFHQGYRNRFLATPWDVFYRPALEHPKPRVLGSQTAMVTGPKGEEIHCDQYGRIKVQFHWDREGLADDKTSCWLRVSSSWAGDRYGAISIPRIGMEVLVTFLEGDPDQPLVTGCLYHKENPVPYALPANKTRSVFKTLSSPGGGGYNELRIEDKKGAEQIFIHAQRDWDENVEHDQKIRVGNERHDTVVKNTYTELKAEEHRTTISDRKVEVKASDHLTVNQDQHIKLGTAQLTSAGKEIHLKAGDKMVIEAGSELTLQAGGSFIKLDGGGITVVGPVVKINAGGSAGTGSGIAILMPLLPIPAPSAKAGNLMAPAQPGVLPTKPEPREYFFDITLTDVPGDEGFPLAHTLWQIVQDGVDQPLLEGQTDENGRVNIDEPQRLKLSKAYAEAGPLWLCYPGQRV